(19) United States
(12) Patent Application Publication
(10) Pub. No.: US 2023/0099999 A1
(43) Pub. Date: Mar. 30, 2023

(54) SYSTEM AND METHOD FOR FILTERING LINEAR FEATURE DETECTIONS ASSOCIATED WITH ROAD LANES

(71) Applicant: HERE Global B.V., Eindhoven (NL)

(72) Inventor: Zhenhua ZHANG, Chicago, IL (US)

(21) Appl. No.: 17/489,341

(22) Filed: Sep. 29, 2021

(51) Int. Cl. G01C 21/26; G01C 21/00

(52) U.S. Cl. CPC G01C 21/26; G01C 21/005

(57) ABSTRACT

A system for filtering a plurality of linear feature detections is provided. The system may determine, from vehicle sensor data, the plurality of linear feature detections associated with a link segment, where each of the plurality of linear feature detections is associated with a respective heading indicative of an orientation. The system further may determine, using map data, a map-based driving direction associated with the link segment. Furthermore, the system may compute a heading difference set associated with the plurality of linear feature detections based on the map-based driving direction, where a given heading difference of the set respectively comprises an angular difference between the map-based driving direction and a respective heading of one of the plurality of linear feature detections. Furthermore, the system may filter the plurality of linear feature detections based on the heading difference set, and one or more of a comparison criterion or a clustering criterion.

### TECHNOLOGICAL FIELD

The present disclosure generally relates to routing and navigation systems, and more particularly relates to methods and systems for filtering linear feature detections in routing and navigation systems.

### BACKGROUND

Currently, various navigation systems are available for vehicle navigation. These navigation systems generally request navigation related data or map data thereof from a navigation service. The map data stored in the navigation service may be updated by using sensor data aggregated from various vehicles. The sensor data may include data about linear feature detections indicative of lane markings, guardrails, roadwork zones, roadwork extensions and the like on a route. The navigation systems based on such navigation related data may be used for vehicle navigation of autonomous, semi-autonomous, or manual vehicles.

Therefore, the sensor data should be accurate to help enable reliable vehicle navigation or the like. However, in many cases, the sensor data may not be accurate or reliable.

### BRIEF SUMMARY OF SOME EXAMPLE EMBODIMENTS

Generally, the sensor data that include the data about the linear feature detections may not be accurate, because sensors equipped in vehicle(s) fail to accurately capture liner features due to noise in sensors, complex road geometries, and/or the like. Accordingly, the linear feature detections may include false positives leading to inaccuracies in the linear feature detections. Hereinafter, ‘false positives’ and ‘incorrect linear feature detections’ may be interchangeably used to mean the same. The incorrect linear feature detections may correspond to one or a combination of: (i) linear feature detections with location deviations, (ii) linear feature detections with abnormal orientation, and (iii) linear feature detections that cross two different lanes.

In order to reduce the inaccuracies in the linear feature detections, a system, a method, and a computer program product are provided in accordance with an example embodiment for filtering the linear feature detections such that the incorrect linear feature detections are discarded or disregarded from the linear feature detections.

In one aspect, a system for filtering a plurality of linear feature detections is disclosed. The system comprises a memory configured to store computer-executable instructions; and at least one processor configured to execute the computer-executable instructions to: determine, from vehicle sensor data, the plurality of linear feature detections associated with a link segment, where each of the plurality of linear feature detections is associated with a respective heading indicative of an orientation; determine, using map data, a map-based driving direction associated with the link segment; based on the map-based driving direction, compute a heading difference set associated with the plurality of linear feature detections, where a given heading difference of the set respectively comprises an angular difference between the map-based driving direction and a respective heading of one of the plurality of linear feature detections; and filter the plurality of linear feature detections based on (i) the heading difference set, and (ii) one or more of a comparison criterion or a clustering criterion.

In additional system embodiments, filtering based on the heading difference set and the clustering criterion comprises: determining that a respective heading difference computed for a particular one of the plurality of linear feature detections is an outlier relative to other heading differences of the set; and based on the respective heading difference computed for the particular linear feature detection being an outlier relative to other heading differences of the set, discarding or disregarding the particular linear feature detection.

In additional system embodiments, determining that the respective heading difference computed for the particular one of the plurality of linear feature detections is the outlier relative to other heading differences of the set comprises: generating two or more heading difference clusters based on the heading difference set, where a given heading difference cluster comprises one or more identical heading differences; identifying an outlier cluster within the generated two or more heading difference clusters; and determining that the respective heading difference computed for the particular linear feature detection is associated with the identified outlier cluster.

In additional system embodiments, filtering based on the heading difference set and the comparison criterion comprises: determining that a respective heading difference computed for a particular one of the plurality of linear feature detections is greater than a heading difference threshold value; and discarding or disregarding the particular linear feature detection based on the respective heading difference computed for the particular linear feature detection being greater than the heading difference threshold value.

In additional system embodiments, the at least one processor is further configured to: determine a distance set based on the plurality of linear feature detections, where a given distance of the distance set respectively comprises a distance between the link segment and a respective linear feature detection of the plurality of linear feature detections; and filter the plurality of linear feature detections, based on the distance set.

In additional system embodiments, filtering based on the distance set comprises discarding or disregarding at least one linear feature detection from the plurality of linear feature detections, when at least one distance corresponding to the at least one linear feature detection is greater than a distance threshold value.

In additional system embodiments, the at least one processor is further configured to: generate one or more distance clusters based on the distance set, where a given distance cluster comprises one or more linear feature detections of the plurality of linear feature detections with identical distances; and filter the plurality of linear feature detections, based on the generated one or more distance clusters.

In additional system embodiments, filtering based on the generated one or more distance clusters comprises: identifying at least one pair of adjacent linear feature detections from the plurality of linear feature detections, based on the generated one or more distance clusters, where one linear feature detection of the identified at least one pair of adjacent linear feature detections is associated with a first distance cluster and another linear feature detection of the identified at least one pair of adjacent linear feature detections is associated with a second distance cluster; and discarding or disregarding the identified at least one pair of adjacent linear feature detections from the plurality of linear feature detections.

In another aspect, a method for filtering a plurality of linear feature detections is provided. The method includes: determining, from vehicle sensor data, the plurality of linear feature detections associated with a link segment, where each of the plurality of linear feature detections is associated with a respective heading indicative of an orientation; determining, using map data, a map-based driving direction associated with the link segment; computing a heading difference set associated with the plurality of linear feature detections, based on the map-based driving direction, where a given heading difference of the set respectively comprises an angular difference between the map-based driving direction and a respective heading of one of the plurality of linear feature detections; determining a distance set based on the plurality of linear feature detections, where a given distance of the distance set respectively comprises a distance between the link segment and a respective linear feature detection of the plurality of linear feature detections; generating one or more distance clusters based on the distance set, where a given distance cluster comprises one or more linear feature detections of the plurality of linear feature detections with identical distances; and filtering the plurality of linear feature detections, based on one or a combination of the heading difference set and the generated one or more distance clusters.

In additional method embodiments, filtering based on the heading difference set comprises: determining that a respective heading difference computed for a particular one of the plurality of linear feature detections is an outlier relative to other heading differences of the set; and based on the respective heading difference computed for the particular linear feature detection being an outlier relative to other heading differences of the set, discarding or disregarding the particular linear feature detection.

In additional method embodiments, determining that the respective heading difference computed for the particular one of the plurality of linear feature detections is the outlier relative to other heading differences of the set comprises: generating two or more heading difference clusters based on the heading difference set, where a given heading difference cluster comprises one or more identical heading differences; identifying an outlier cluster within the generated two or more heading difference clusters; and determining that the respective heading difference computed for the particular linear feature detection is associated with the identified outlier cluster.

In additional method embodiments, filtering based on the heading difference set comprises: determining that a respective heading difference computed for a particular one of the plurality of linear feature detections is greater than a heading difference threshold value; and discarding or disregarding the particular linear feature detection based on the respective heading difference computed for the particular linear feature detection being greater than the heading difference threshold value.

In additional method embodiments, filtering based on the generated one or more distance clusters comprises: identifying at least one pair of adjacent linear feature detections from the plurality of linear feature detections, based on the generated one or more distance clusters, where one linear feature detection of the identified at least one pair of adjacent linear feature detections is associated with a first distance cluster and another linear feature detection of the identified at least one pair of adjacent linear feature detections is associated with a second distance cluster; and discarding or disregarding the identified at least one pair of adjacent linear feature detections from the plurality of linear feature detections.

In additional method embodiments, the method further includes filtering the plurality of linear feature detections, based on the distance set, where filtering based on the distance set comprises discarding or disregarding at least one linear feature detection from the plurality of linear feature detections, when at least one distance corresponding to the at least one linear feature detection is greater than a distance threshold value.

In yet another aspect, a computer program product comprising a non-transitory computer readable medium having stored thereon computer executable instruction which when executed by at least one processor, cause the at least one processor to carry out operations for filtering a plurality of linear feature detections, the operation comprising: determining, from vehicle sensor data, the plurality of linear feature detections associated with a link segment, where each of the plurality of linear feature detections is associated with a respective heading indicative of an orientation; determining, using map data, a map-based driving direction associated with the link segment; computing a heading difference set associated with the plurality of linear feature detections, based on the map-based driving direction, where a given heading difference of the set respectively comprises an angular difference between the map-based driving direction and a respective heading of one of the plurality of linear feature detections; determining a distance set based on the plurality of linear feature detections, where a given distance of the distance set respectively comprises a distance between the link segment and a respective linear feature detection of the plurality of linear feature detections; generating one or more distance clusters based on the distance set, where a given distance cluster comprises one or more linear feature detections of the plurality of linear feature detections with identical distances; and filtering the plurality of linear feature detections, based on one or a combination of the heading difference set, the distance set, and the generated one or more distance clusters.

In additional computer program product embodiments, for filtering based on the heading difference set, the operations further comprise: determining that a respective heading difference computed for a particular one of the plurality of linear feature detections is an outlier relative to other heading differences of the set; and based on the respective heading difference computed for the particular linear feature detection being an outlier relative to other heading differences of the set, discarding or disregarding the particular linear feature detection.

In additional computer program product embodiments, determining that the respective heading difference computed for the particular one of the plurality of linear feature detections is the outlier relative to other heading differences of the set comprises: generating two or more heading difference clusters based on the heading difference set, where a given heading difference cluster comprises one or more identical heading differences; identifying an outlier cluster within the generated two or more heading difference clusters; and determining that the respective heading difference computed for the particular linear feature detection is associated with the identified outlier cluster.

In additional computer program product embodiments, for filtering based on the heading difference set, the operations further comprise: determining that a respective heading difference computed for a particular one of the plurality of linear feature detections is greater than a heading difference threshold value; and discarding or disregarding the particular linear feature detection based on the respective heading difference computed for the particular linear feature detection being greater than the heading difference threshold value.

In additional computer program product embodiments, for filtering based on the generated one or more distance clusters, the operations further comprise: identifying at least one pair of adjacent linear feature detections from the plurality of linear feature detections, based on the generated one or more distance clusters, where one linear feature detection of the identified at least one pair of adjacent linear feature detections is associated with a first distance cluster and another linear feature detection of the identified at least one pair of adjacent linear feature detections is associated with a second distance cluster; and discarding or disregarding the identified at least one pair of adjacent linear feature detections from the plurality of linear feature detections.

In additional computer program product embodiments, for filtering based on the distance set, the operation further comprise filtering at least one linear feature detection from the plurality of linear feature detections, when at least one distance corresponding to the at least one linear feature detection is greater than a distance threshold value.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 illustrates a block diagram showing a network environment of a system for filtering linear feature detections, in accordance with one or more example embodiments;

FIG. 2A illustrates a schematic diagram showing linear feature detections, in accordance with one or more example embodiments;

FIG. 2B shows format of map data stored in a map database, in accordance with one or more example embodiments;

FIG. 2C shows another format of map data stored in the map database, in accordance with one or more example embodiments;

FIG. 2D illustrates a block diagram of the map database, in accordance with one or more example embodiments;

FIG. 3 illustrates a block diagram of the system for filtering the linear feature detections, in accordance with one or more example embodiment;

FIG. 4A illustrates a working environment of the system for filtering the linear feature detections, in accordance with one or more example embodiments;

FIG. 4B illustrates a schematic diagram showing the linear feature detections associated with a link segment, in accordance with one or more example embodiments;

FIG. 4C illustrates a schematic diagram for determining an orientation, in accordance with one or more example embodiment;

FIG. 4D illustrates a flowchart for filtering the linear feature detections based on a heading difference set and a comparison criterion, in accordance with one or more example embodiments;

FIG. 4E illustrates a graphical representation for filtering the linear feature detections based on the heading difference set and a clustering criterion, in accordance with one or more example embodiments;

FIG. 5 illustrates a schematic diagram showing the linear feature detections that include incorrect linear feature detections with location deviations, in accordance with one or more example embodiments;

FIG. 6A illustrates a schematic diagram showing the linear feature detections that include incorrect linear feature detections crossing two different lanes, in accordance with one or more example embodiments;

FIG. 6B illustrates a schematic diagram for generating one or more distance clusters, in accordance with one or more example embodiments; and

FIG. 7 illustrates a flowchart depicting a method for filtering the linear feature detections, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses, systems, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium” refers to a non-transitory physical storage medium (for example, volatile or non-volatile memory device), which may be differentiated from a “computer-readable transmission medium” that refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

A system, a method, and a computer program product are provided herein for filtering a plurality of linear feature detections. Various embodiments are provided for determining, from vehicle sensor data, the plurality of linear feature detections associated with a link segment. For instance, the linear feature detections may correspond to sensor observations that are indicative of data (e.g. image data) of a linear feature. As used herein, the linear feature may correspond to a border of the link segment (and/or a border of a lane of the link segment), where the border may be represented by one or more of lane markings, guardrails, road curbs, road medians, road barriers, and the like. In some embodiments, each of the plurality of linear feature detections may be associated with a respective heading indicative of an orientation. Various embodiments are provided for determining, using map data, a map-based diving direction associated with the link segment.

Various embodiments are provided for computing a heading difference set associated with the plurality of linear feature detections, based on the map-based driving direction. In some embodiments, the heading difference set may be computed such that each heading difference of the set comprises an angular difference between the map-based driving direction and a respective heading of one of the plurality of linear feature detections.

Various embodiments are provided for filtering the plurality of linear feature detections, based on the heading difference set. In some embodiments, the plurality of linear feature detections may be filtered based on the heading difference set and a comparison criterion. In some other embodiments, the plurality of linear feature detections may be filtered based on the heading difference set and a clustering criterion. In both these embodiments, the plurality of linear feature detections may be filtered such that the incorrect linear feature detections are discarded or disregarded from the plurality of linear feature detections. In various embodiments, after discarding or disregarding the incorrect linear feature detections, the plurality of linear feature detections may be used to provide one or more navigation functions. Some non-limiting examples of the navigation functions includes providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

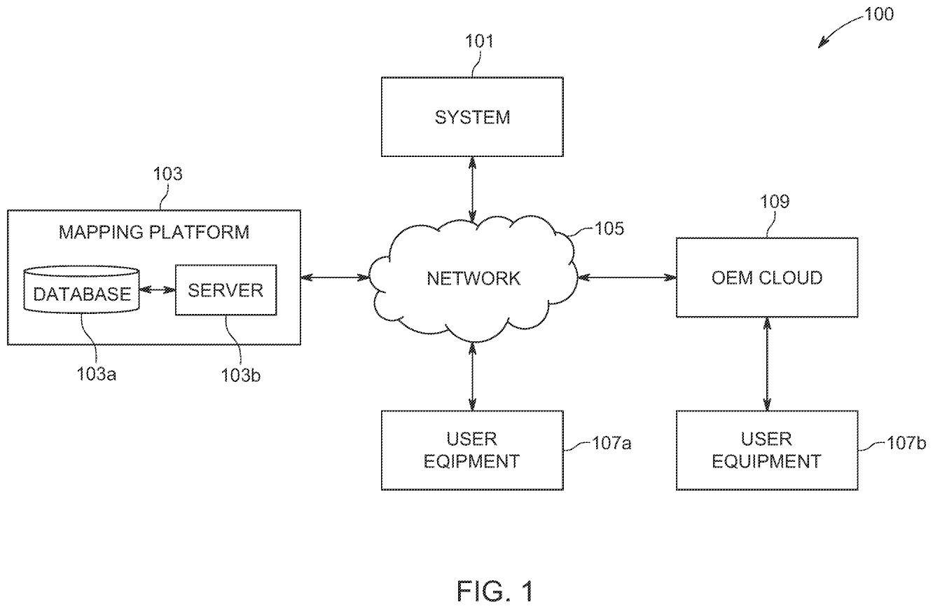

FIG. 1 illustrates a block diagram 100 showing a network environment of a system 101 for filtering linear feature detections, in accordance with one or more example embodiments. The system 101 may be communicatively coupled, via a network 105, to one or more of a mapping platform 103, a user equipment 107a, and/or an OEM (Original Equipment Manufacturer) cloud 109. The OEM cloud 109 may be further connected to a user equipment 107b. The components described in the block diagram 100 may be further broken down into more than one component such as one or more sensors or application in user equipment and/or combined together in any suitable arrangement. Further, it is possible that one or more components may be rearranged, changed, added, and/or removed without deviating from the scope of the present disclosure.

In an example embodiment, the system 101 may be embodied in one or more of several ways as per the required implementation. For example, the system 101 may be embodied as a cloud-based service, a cloud-based application, a cloud-based platform, a remote server-based service, a remote server-based application, a remote server-based platform, or a virtual computing system. As such, the system 101 may be configured to operate inside the mapping platform 103 and/or inside at least one of the user equipment 107a and the user equipment 107b.

In some embodiments, the system 101 may be embodied within one or both of the user equipment 107a and the user equipment 107b, for example as a part of an in-vehicle navigation system, a navigation app in a mobile device and the like. In each of such embodiments, the system 101 may be communicatively coupled to the components shown in FIG. 1 to carry out the desired operations and wherever required modifications may be possible within the scope of the present disclosure. The system 101 may be implemented in a vehicle, where the vehicle may be an autonomous vehicle, a semi-autonomous vehicle, or a manually driven vehicle. In an embodiment, the system 101 may be deployed in a consumer vehicle to filter the linear feature detections.

In some other embodiments, the system 101 may be a server 103b of the mapping platform 103 and therefore may be co-located with or within the mapping platform 103. In yet other embodiments, the system 101 may be implemented within an OEM (Original Equipment Manufacturer) cloud, such as the OEM cloud 109. The OEM cloud 109 may be configured to anonymize any data received from the system 101, such as the vehicle, before using the data for further processing, such as before sending the data to the mapping platform 103. In some embodiments, anonymization of data may be done by the mapping platform 103. Further, in yet other embodiments, the system 101 may be a standalone unit configured to filter the linear feature detections for the vehicle. Additionally, the system 101 may be coupled with an external device such as the autonomous vehicle.

The mapping platform 103 may include a map database 103a (also referred to as geographic database 103a) for storing map data and a processing server 103b for carrying out the processing functions associated with the mapping platform 103. The map database 103a may store node data, road segment data (also referred to as link data), point of interest (POI) data, road obstacles related data, traffic objects related data, posted signs related data, such as road sign data, or the like. The map database 103a may also include cartographic data and/or routing data. According to some example embodiments, the link data may be stored in link data records, where the link data may represent link segments (or road segments) representing roads, streets, or paths, as may be used in calculating a route or recorded route information for determination of one or more personalized routes. The node data may be stored in node data records, where the node data may represent end points corresponding to the respective links or segments of the link data. One node represents a point at one end of the respective link segment and the other node represents a point at the other end of the respective link. The node at either end of a link segment corresponds to a location at which the road meets another road, e.g., an intersection, or where the road dead ends. An intersection may not necessarily be a place at which a turn from one road to another is permitted but represents a location at which one road and another road have the same latitude, longitude, and elevation. In some cases, a node may be located along a portion of a road between adjacent intersections, e.g., to indicate a change in road attributes, a railroad crossing, or for some other reason. (The terms “node” and “link” represent only one terminology for describing these physical geographic features and other terminology for these features is intended to be encompassed within the scope of these concepts.) The link data and the node data may represent a road network used by vehicles such as cars, trucks, buses, motorcycles, and/or other entities.

Additionally, the map database 103a may contain path segment and node data records, or other data that may represent pedestrian paths or areas in addition to or instead of the vehicle road record data, for example. The links/road segments and nodes may be associated with attributes, such as geographic coordinates and other navigation related attributes, as well as POIs, such as fueling stations, hotels, restaurants, museums, stadiums, offices, auto repair shops, buildings, stores, parks, etc. The navigation related attributes may include one or more of travel speed data (e.g. data indicative of a permitted speed of travel) on the road represented by the link data record, map-based driving direction data (e.g. data indicative of a permitted direction of travel) on the road represented by the link data record, linear feature data on the road represented by the link data record, street address ranges of the road represented by the link data record, the name of the road represented by the link data record, and the like. As used herein, ‘linear feature data’ may be data indicative of a linear feature along the road represented by the link data record. The linear feature may be at least one of lane markings, road curbs, guardrails, road medians, road barriers, and the like along the road. In an embodiment, the linear feature data may be updated using linear feature detections. As used herein, ‘linear feature detections’ may correspond to sensor-based observations of the linear feature along the road. These various navigation related attributes associated with a link segment may be stored in a single data record or may be stored in more than one type of record.

Each link data record that represents other-than-straight link (for example, a curved link segment) may include shape location data. A shape location is a location along a link segment between its endpoints. For instance, to represent the shape of other-than-straight roads/links, a geographic database developer may select one or more shape locations along the link portion. The shape location data included in the link data record may indicate a position, (e.g., latitude, longitude, and optionally, altitude or elevation) of the selected shape point(s) along the represented link.

Additionally, the map database 103a may also include data about the POIs and their respective locations in the POI records. The map database 103a may further include data about places, such as cities, towns, or other communities, and other geographic features such as bodies of water, mountain ranges, etc. Such place or feature data may be part of the POI data or may be associated with POIs or POI data records (such as a data point used for displaying a city). In addition, the map database 103a may include event data (e.g., traffic incidents, construction activities, scheduled events, unscheduled events, etc.) associated with the POI data records or other records of the map database 103a.

The map database 103a may be maintained by a content provider e.g., a map developer. By way of example, the map developer may collect the map data to generate and enhance the map database 103a. There may be different ways used by the map developer to collect data. These ways may include obtaining data from other sources, such as municipalities or respective geographic authorities. In addition, the map developer may employ field personnel to travel by vehicle (also referred to as a dedicated vehicle) along roads throughout a geographic region to observe features and/or record information about them, for example. Also, remote sensing, such as aerial or satellite photography, may be used to collect the map data. In some example embodiments, the map data in the map database 103a may be stored as a digital map. The digital map may correspond to satellite raster imagery, bitmap imagery, or the like. The satellite raster imagery/bitmap imagery may include map features (such as link/road segments, nodes, and the like) and the navigation related attributes associated with the map features. In some embodiments, the map features may have a vector representation form. Additionally, the satellite raster imagery may include three-dimensional (3D) map data that corresponds to 3D map features, which are defined as vectors, voxels, or the like.

According to some embodiments, the map database 103a may be a master map database stored in a format that facilitates updating, maintenance and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, the map data may be compiled (such as into a platform specification format (PSF format)) to organize and/or configure the data for performing navigation-related functions and/or services, such as route calculation, route guidance, map display, speed calculation, distance and travel time functions, navigation instruction generation and other functions, by a navigation device, such as by the user equipment 107a and/or 107b. The navigation-related functions may correspond to vehicle navigation, pedestrian navigation, navigation instruction suppression, navigation instruction generation based on user preference data or other types of navigation. The compilation to produce the end user databases may be performed by a party or entity separate from a map developer. For example, a customer of the map developer, such as a navigation device developer or other end user device developer, a navigation app service provider and the like may perform compilation on a received map database in a delivery format to produce one or more compiled navigation databases.

As mentioned above, the map database 103a may be the master geographic database, but in alternate embodiments, the map database 103a may be embodied as a client-side map database and may represent a compiled navigation database that may be used in or with end user equipment such as the user equipment 107a and/or the user equipment 107b to provide navigation and/or map-related functions. For example, the map database 103a may be used with the user equipment 107a and/or the user equipment 107b to provide an end user with navigation features. In such a case, the map database 103a may be downloaded or stored locally (cached) on the user equipment 107a and/or the user equipment 107b.

The processing server 103b may include processing means, and communication means. For example, the processing means may include one or more processors configured to process requests received from the user equipment 107a and/or the user equipment 107b. The processing means may fetch map data from the map database 103a and transmit the same to the user equipment 107b via the OEM cloud 109 in a format suitable for use by the one or both of the user equipment 107a and/or the user equipment 107b. In one or more example embodiments, the mapping platform 103 may periodically communicate with the user equipment 107a and/or the user equipment 107b via the processing server 103b to update a local cache of the map data stored on the user equipment 107a and/or the user equipment 107b. Accordingly, in some example embodiments, the map data may also be stored on the user equipment 107a and/or the user equipment 107b and may be updated based on periodic communication with the mapping platform 103 via the network 105.

The network 105 may be wired, wireless, or any combination of wired and wireless communication networks, such as cellular, Wi-Fi, internet, local area networks, or the like. In one embodiment, the network 105 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In some example embodiments, the user equipment 107a and the user equipment 107b may be any user accessible device such as a mobile phone, a smartphone, a portable computer, and the like that are portable in themselves or as a part of another portable/mobile object such as a vehicle. The user equipment 107a and 107b may include a processor, a memory, and a communication interface. The processor, the memory, and the communication interface may be communicatively coupled to each other. In some example embodiments, the user equipment 107a and 107b may be associated, coupled, or otherwise integrated with a vehicle, such as an advanced driver assistance system (ADAS), a personal navigation device (PND), a portable navigation device, an infotainment system and/or other device that may be configured to provide route guidance and navigation related functions to the user. In such example embodiments, the user equipment 107a and 107b may include processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment 107a and 107b. For example, the user equipment 107a and 107b may be configured to execute and run mobile applications such as a messaging application, a browser application, a navigation application, and the like.

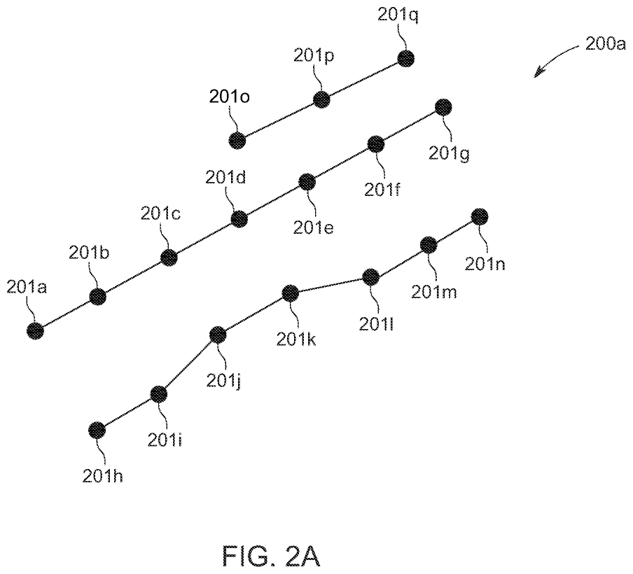

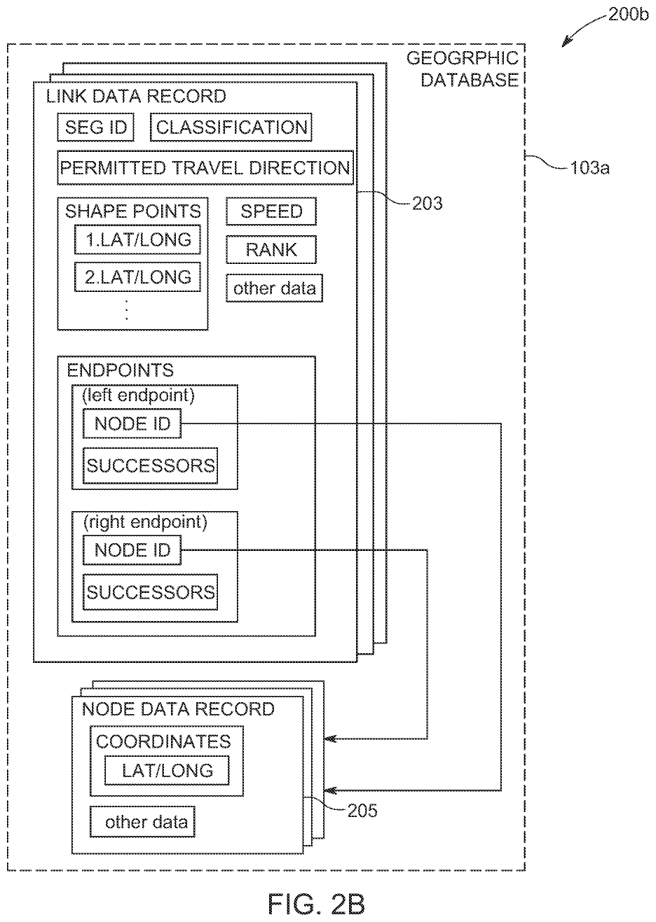

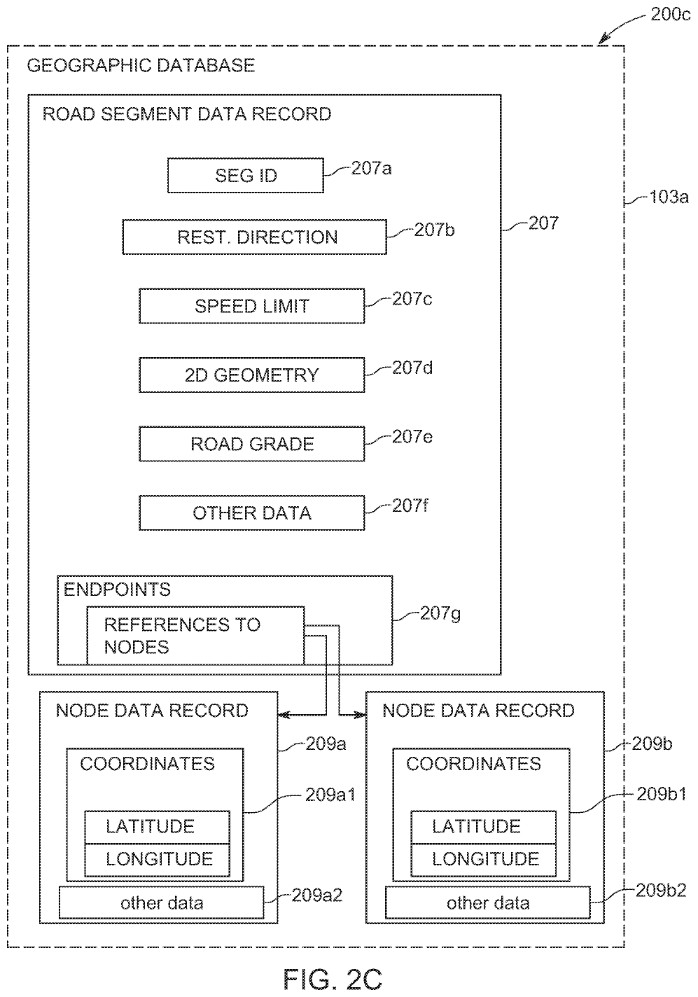

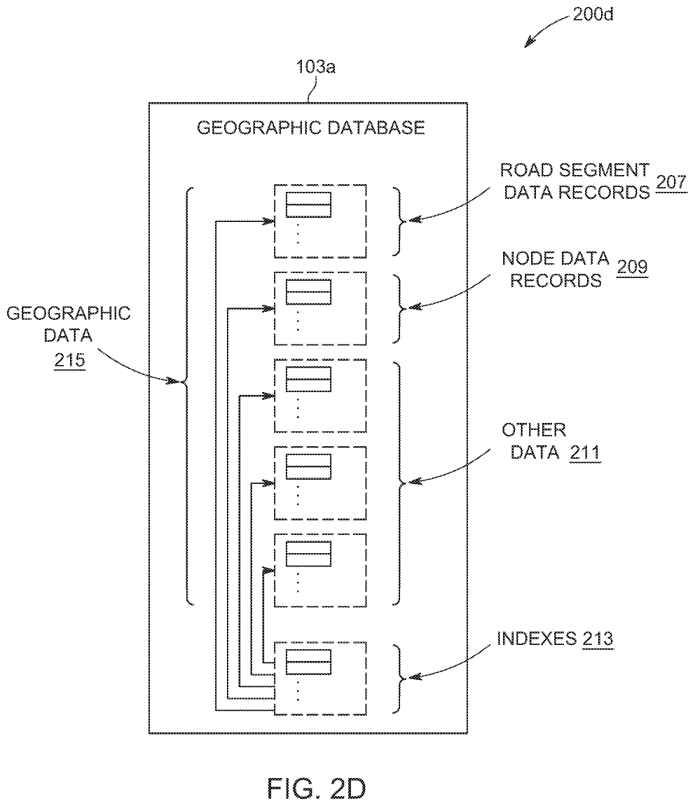

In one embodiment, at least one user equipment such as the user equipment 107a may be directly coupled to the system 101 via the network 105. For example, the user equipment 107a may be a dedicated vehicle (or a part thereof) for gathering data for development of the map data stored in the map database 103a. In another embodiment, at least one user equipment such as the user equipment 107b may be coupled to the system 101 via the OEM cloud 109 and the network 105. For example, the user equipment 107b may be a consumer vehicle or a probe vehicle (or a part thereof) and may be a beneficiary of the services provided by the system 101. In some example embodiments, one or more of the user equipment 107a and 107b may serve the dual purpose of a data gatherer and a beneficiary device. At least one of the user equipment 107a and 107b may be configured to capture sensor data associated with the link/road segment, while traversing along the link/road segment. For instance, the sensor data may include linear feature detections of the linear feature along the link/road segment, among other things. For example, the linear feature detections may correspond to image data of the linear feature along the link/road segment. The sensor data may be collected from one or more sensors in the user equipment 107a and/or user equipment 107b. As disclosed in conjunction with various embodiments disclosed herein, the system 101 may filter the linear feature detections included in the sensor data to update and/or generate the linear feature data. For example, the linear feature detections of the linear feature(s) along the link/road segment may be as illustrated FIG. 2A.

FIG. 2A illustrates a schematic diagram 200a showing linear feature detections, in accordance with one or more example embodiments. For instance, the schematic diagram 200a illustrates sensor observations made for a particular lane of a link segment (or a particular link segment with one lane). For instance, the sensor observations may include a plurality of linear feature detection points 201a, 201b, 201c, . . . , and 201q. For example, each of the plurality of linear feature detection points 201a, 201b, 201c, . . . , and 201q may correspond to image data indicative of the linear feature associated with the particular lane (or the particular link segment). For instance, the linear feature may be at least one of lane markings, road curbs, guardrails, road medians, road barriers, and the like. In an embodiment, these plurality of linear feature detection points 201a, 201b, 201c, . . . , and 201q may be collected from the one or more sensors associated with one or more user equipment (such as the user equipment 107a and/or user equipment 107b). Hereinafter, ‘linear feature detection point’ and ‘linear feature detection’ may interchangeably be used to mean the same.

Some embodiments are based on the recognition that these plurality of linear feature detections 201a, 201b, 201c, . . . , and 201q may include one or more incorrect linear feature detections. For example, the incorrect linear feature detections may include (i) linear feature detections with location deviations and (ii) linear feature detections with abnormal orientation. For instance, the linear feature detections with location deviations may correspond to the linear feature detections 201o, 201p, and 201q. For example, the plurality of linear feature detections includes the linear feature detections 201o, 201p, and 201q with location deviations, when the one or more sensors record lane markings associated with next parallel link segments, markings associated with parking areas of the road, or the like as the linear feature detections. For instance, the linear feature detections with abnormal orientations may correspond to the linear feature detections 201j and 201k. For example, the plurality of linear feature detections includes the linear feature detections 201j and 201k with the abnormal orientations, when the one or more sensors fail to accurately record the linear feature. Additionally, the incorrect linear feature detections may include linear feature detections that cross two different lanes. The purpose of the methods and systems (such as the system 101) disclosed herein, is to filter the plurality of linear feature detections 201a, 201b, 201c, . . . , and 201q such that the incorrect linear feature detections are discarded or disregarded for accurate navigation. In an embodiment, the system 101 may further update the map database (such as map database 103a), based on the filtered linear feature detections. This ensures that the map data stored in the map database 103a is highly accurate and up to date. For purpose of explanation, ‘linear feature detection’ is considered to be equivalent to ‘linear feature point’. Alternatively, ‘linear feature detection’ may correspond to ‘linear feature line between two adjacent linear feature points’. In some embodiments, the linear feature detections are associated with corresponding links, and data about the linear feature detections may be stored in the link data records of the map database 103a.

FIG. 2B shows format of map data 200b stored in the map database 103a, in accordance with one or more example embodiments. FIG. 2B shows a link data record 203 that may be used to store data about the linear feature detections. The link data record 203 has information (such as “attributes”, “fields”, etc.) associated with it that allows identification of the nodes associated with the link segment and/or the geographic positions (e.g., the latitude and longitude coordinates and/or altitude or elevation) of the two nodes. In addition, the link data record 203 may have information (e.g., more “attributes”, “fields”, etc.) associated with it that specify the permitted speed of travel on the portion of the road represented by the link record, the direction of travel permitted on the road portion represented by the link record, what, if any, turn restrictions exist at each of the nodes which correspond to intersections at the ends of the road portion represented by the link record, the street address ranges of the roadway portion represented by the link record, the name of the road, and so on. The various attributes associated with a link segment may be included in a single data record or are included in more than one type of record which are referenced to each other.

Each link data record that represents another-than-straight road segment may include shape point data. A shape point is a location along a link segment between its endpoints. To represent the shape of other-than-straight roads, the mapping platform 103 and its associated map database developer selects one or more shape points along the other-than-straight road portion. Shape point data included in the link data record 203 indicate the position, (e.g., latitude, longitude, and optionally, altitude or elevation) of the selected shape points along the represented link.

Additionally, there may also be a node data record 205 for each node. The node data record 205 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the particular associated function, but excludes data and attributes that are not needed for performing the function. Thus, the map data may be alternately stored in a format suitable for performing types of navigation functions, and further may be provided on-demand, depending on the type of navigation function.

FIG. 2C shows another format of map data 200c stored in the map database 103a, in accordance with one or more example embodiments. In the FIG. 2C, the map data 200c is stored by specifying a road segment data record 207. The road segment data record 207 is configured to represent data that represents a road network. In FIG. 2C, the map database 103a contains at least one road segment data record 207 (also referred to as “entity” or “entry”) for each road segment in a geographic region.

The map database 103a that represents the geographic region also includes a database record 209 (a node data record 209a and a node data record 209b) (or “entity” or “entry”) for each node associated with the at least one road segment shown by the road segment data record 207. Each of the node data records 209a and 209b may have associated information (such as “attributes”, “fields”, etc.) that allows identification of the road segment(s) that connect to it and/or its geographic position (e.g., its latitude and longitude coordinates).

FIG. 2C shows some of the components of the road segment data record 207 contained in the map database 103a. The road segment data record 207 includes a segment ID 207a by which the data record can be identified in the map database 103a. Each road segment data record 207 has associated with it information (such as “attributes”, “fields”, etc.) that describes features of the represented road segment. The road segment data record 207 may include data 207b that indicate the restrictions, if any, on the direction of vehicular travel permitted on the represented road segment. The road segment data record 207 includes data 207c that indicate a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day or weather. The static speed limit is the sign posted explicit speed limit for the road segment, or the non-sign posted implicit general speed limit based on legislation.

The road segment data record 207 may also include data 207d indicating the two-dimensional (“2D”) geometry or shape of the road segment. If a road segment is straight, its shape can be represented by identifying its endpoints or nodes. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 207 also includes road grade data 207e that indicate the grade or slope of the road segment. In one embodiment, the road grade data 207e include road grade change points and a corresponding percentage of grade change. Additionally, the road grade data 207e may include the corresponding percentage of grade change for both directions of a bi-directional road segment. The location of the road grade change point is represented as a position along the road segment, such as thirty feet from the end or node of the road segment. For example, the road segment may have an initial road grade associated with its beginning node. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 207e includes the road grade change points and an actual road grade value for the portion of the road segment after the road grade change point until the next road grade change point or end node. In a further embodiment, the road grade data 207e includes elevation data at the road grade change points and nodes. In an alternative embodiment, the road grade data 207e is an elevation model which may be used to determine the slope of the road segment.

The road segment data record 207 also includes data 207g providing the geographic coordinates (e.g., the latitude and longitude) of the end points of the represented road segment. In one embodiment, the data 207g are references to the node data records 209 that represent the nodes corresponding to the end points of the represented road segment.

The road segment data record 207 may also include or be associated with other data 207f that refer to various other attributes of the represented road segment. The various attributes associated with a road segment may be included in a single road segment record, or may be included in more than one type of record which cross-reference each other. For example, the road segment data record 207 may include data identifying the name or names by which the represented road segment is known, the street address ranges along the represented road segment, and so on.

FIG. 2C also shows some of the components of the node data record 209 contained in the map database 103a. Each of the node data records 209 may have associated information (such as “attributes”, “fields”, etc.) that allows identification of the road segment(s) that connect to it and/or it's geographic position (e.g., its latitude and longitude coordinates). For the embodiment shown in FIG. 2C, the node data records 209a and 209b include the latitude and longitude coordinates 209a1 and 209b1 for their nodes. The node data records 209a and 209b may also include other data 209a2 and 209b2 that refer to various other attributes of the nodes.

Thus, the overall data stored in the map database 103a may be organized in the form of different layers for greater detail, clarity and precision. Specifically, in the case of high definition maps, the map data may be organized, stored, sorted and accessed in the form of three or more layers. These layers may include road level layer, lane level layer and localization layer. The data stored in the map database 103a in the formats shown in FIGS. 2B and 2C may be combined in a suitable manner to provide these three or more layers of information. In some embodiments, there may be lesser or fewer number of layers of data also possible, without deviating from the scope of the present disclosure.

FIG. 2D illustrates a block diagram 200d of the map database 103a, in accordance with one or more example embodiments. The map database 103a stores map data or geographic data 215 in the form of road segments/links, nodes, and one or more associated attributes as discussed above. Furthermore, attributes may refer to features or data layers associated with the link-node database, such as an HD lane data layer.

In addition, the map data 215 may also include other kinds of data 211. The other kinds of data 211 may represent other kinds of geographic features or anything else. The other kinds of data may include point of interest data. For example, the point of interest data may include point of interest records comprising a type (e.g., the type of point of interest, such as restaurant, hotel, city hall, police station, historical marker, ATM, golf course, etc.), location of the point of interest, a phone number, hours of operation, etc. The map database 103a also includes indexes 213. The indexes 213 may include various types of indexes that relate the different types of data to each other or that relate to other aspects of the data contained in the geographic database 103a.

The data stored in the map database 103a in the various formats discussed above may help in provide precise data for high-definition mapping applications, autonomous vehicle navigation and guidance, cruise control using ADAS, direction control using accurate vehicle maneuvering and other such services. In some embodiments, the system 101 accesses the map database 103a storing data in the form of various layers and formats depicted in FIGS. 2B-2D, to filter the plurality of linear feature detections (e.g. the plurality of linear feature detections 201a, 201b, 201c, . . . , and 201q) such that the incorrect linear feature detections are discarded or disregarded.

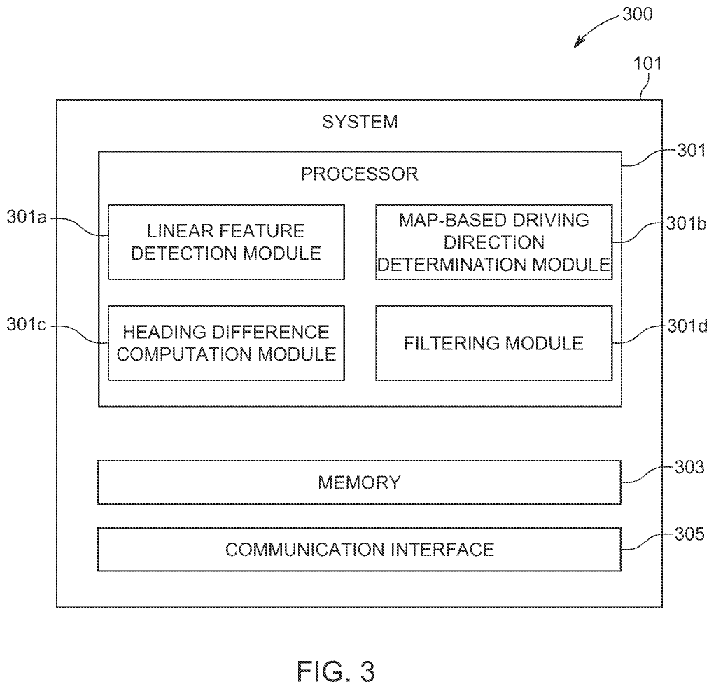

FIG. 3 illustrates a block diagram 300 of the system 101 for filtering the linear feature detections, in accordance with one or more example embodiment. The system 101 may include at least one processor 301, a memory 303, and a communication interface 305. Further, the system 101 may include a linear feature detection module 301a, a map-based driving direction determination module 301b, a heading difference computation module 301c, and a filtering module 301d. In an embodiment, the linear feature detection module 301a may be configured to determine, from vehicle sensor data, the plurality of linear feature detections (e.g. the linear feature detections 201a, 201b, 201c, . . . , 201q) associated with a link segment. As used herein, ‘vehicle sensor data’ may correspond to the sensor data obtained from one or more vehicles. In an example embodiment, each of the plurality of linear feature detections may be associated with a respective heading. For instance, the heading may be indicative of a detected driving direction of the one or more vehicles. In an embodiment, the map-based driving direction determination module 301b may be configured to determine, using map data, the map-based driving direction associated with the link segment. In an embodiment, the heading difference computation module 301c may be configured to compute a heading difference set associated with one or more of the plurality of linear feature detections, based on the map-based driving direction. In an example embodiment, a given heading difference of the set respectively comprises an angular difference between the map-based driving direction and a respective heading of one of the plurality of linear feature detections. In an embodiment, the filtering module 301d may be configured to filter the plurality of linear feature detections based on (i) the heading difference set, and (ii) one or more of a comparison criterion or a clustering criterion. In an example embodiment, the filtering module 301d may filter the plurality of linear feature detections such that the incorrect linear feature detections are discarded or disregarded.

According to an embodiment, each of the modules 301a-301d may be embodied in the processor 301. The processor 301 may retrieve computer-executable instructions that may be stored in the memory 303 for execution of the computer-executable instructions, which when executed configures the processor 301 for filtering the plurality of linear feature detections.

The processor 301 may be embodied in a number of different ways. For example, the processor 301 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 301 may include one or more processing cores configured to perform independently. A multi-core processor may enable multiprocessing within a single physical package. Additionally, or alternatively, the processor 301 may include one or more processors configured in tandem via the bus to enable independent execution of instructions, pipelining and/or multithreading.

Additionally, or alternatively, the processor 301 may include one or more processors capable of processing large volumes of workloads and operations to provide support for big data analysis. In an example embodiment, the processor 301 may be in communication with the memory 303 via a bus for passing information to mapping platform 303. The memory 303 may be non-transitory and may include, for example, one or more volatile and/or non-volatile memories. In other words, for example, the memory 303 may be an electronic storage device (for example, a computer readable storage medium) comprising gates configured to store data (for example, bits) that may be retrievable by a machine (for example, a computing device like the processor 301). The memory 303 may be configured to store information, data, content, applications, instructions, or the like, for enabling the system 101 to carry out various functions in accordance with an example embodiment of the present disclosure. For example, the memory 303 may be configured to buffer input data for processing by the processor 301. As exemplarily illustrated in FIG. 3, the memory 303 may be configured to store instructions for execution by the processor 301. As such, whether configured by hardware or software methods, or by a combination thereof, the processor 301 may represent an entity (for example, physically embodied in circuitry) capable of performing operations according to an embodiment of the present disclosure while configured accordingly. Thus, for example, when the processor 301 is embodied as an ASIC, FPGA or the like, the processor 301 may be specifically configured hardware for conducting the operations described herein. Alternatively, as another example, when the processor 301 is embodied as an executor of software instructions, the instructions may specifically configure the processor 301 to perform the algorithms and/or operations described herein when the instructions are executed. However, in some cases, the processor 301 may be a processor specific device (for example, a mobile terminal or a fixed computing device) configured to employ an embodiment of the present disclosure by further configuration of the processor 301 by instructions for performing the algorithms and/or operations described herein. The processor 301 may include, among other things, a clock, an arithmetic logic unit (ALU) and logic gates configured to support operation of the processor 301.

In some embodiments, the processor 301 may be configured to provide Internet-of-Things (IoT) related capabilities to a user of the system 101, where the user may be a traveler, a driver of the vehicle and the like. In some embodiments, the user may be or correspond to an autonomous or semi-autonomous vehicle. The IoT related capabilities may in turn be used to provide smart navigation solutions by providing real time updates to the user to take pro-active decision on lane maintenance, speed determination, lane-level speed determination, turn-maneuvers, lane changes, overtaking, merging and the like. The system 101 may be accessed using the communication interface 305. The communication interface 305 may provide an interface for accessing various features and data stored in the system 101. For example, the communication interface 305 may include I/O interface which may be in the form of a GUI, a touch interface, a voice enabled interface, a keypad, and the like. For example, the communication interface 305 may be a touch enabled interface of a navigation device installed in a vehicle, which may also display various navigation related data to the user of the vehicle. Such navigation related data may include information about upcoming conditions on a route, route display and alerts about lane maintenance, turn-maneuvers, vehicle speed, and the like.

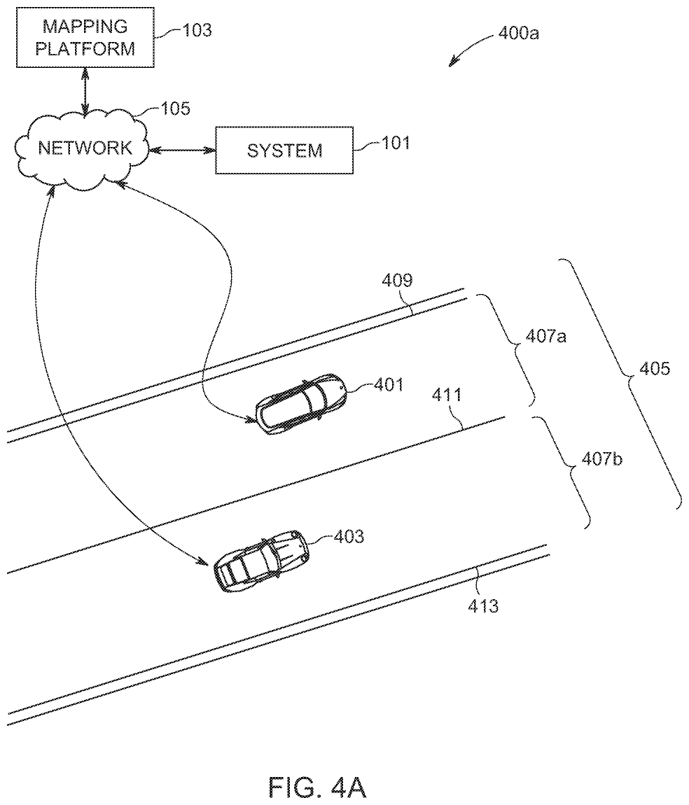

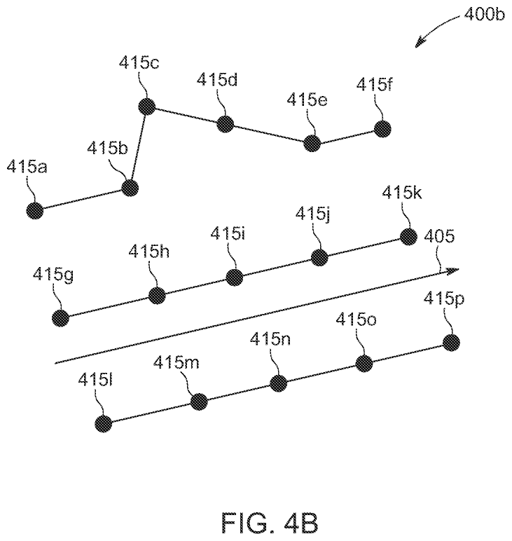

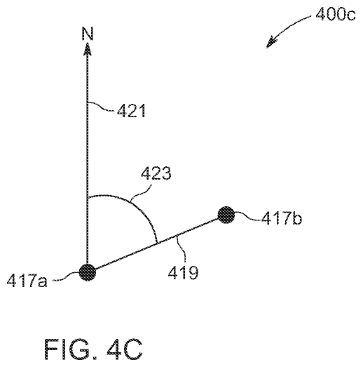

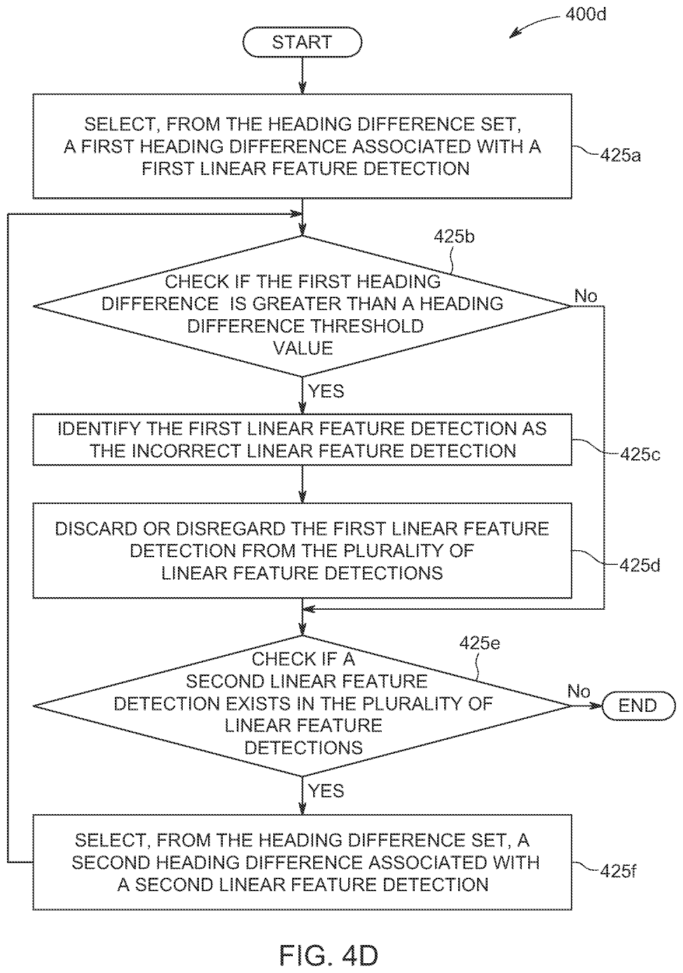

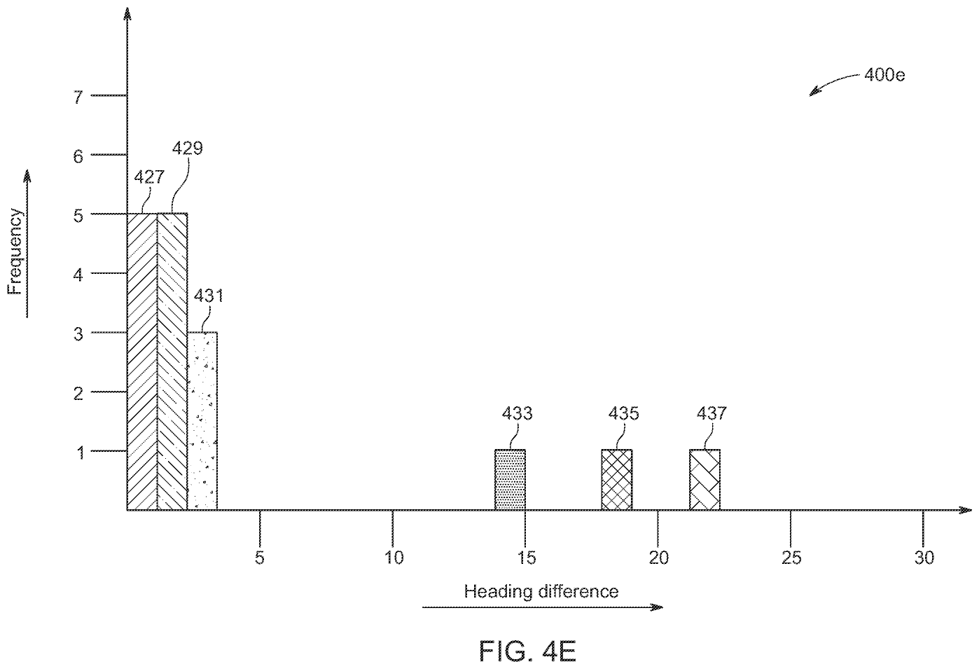

FIG. 4A illustrates a working environment 400a of the system 101 for filtering the linear feature detections, in accordance with one or more example embodiments. As illustrated in FIG. 4A, the working environment 400a includes the system 101, the mapping platform 103, the network 105, one or more vehicles 401 and 403, a link segment 405, linear features 409, 411, and 413. Each of the one or more vehicles 401 and 403 may correspond to any one of: an autonomous vehicle, a semi-autonomous vehicle, or a manual vehicle. As used herein, the autonomous vehicle may be a vehicle that is capable of sensing its environment and operating without human involvement. For instance, the autonomous vehicle may be a self-driving car and the like. As used herein, the ‘vehicle’ may include a motor vehicle, a non-motor vehicle, an automobile, a car, a scooter, a truck, a van, a bus, a motorcycle, a bicycle, a Segway, and/or the like.

As used herein, the ‘link segment’ (e.g. the link segment 405) may be a road segment between two nodes. The link segment 405 may be a freeway, an expressway, a highway, or the like. For instance, the link segment 405 may include two lanes 407a and 407b as illustrated in FIG. 4A. For purpose of explanation, the link segment 405 having two lanes 407a and 407b is considered. However, the link segment 405 may have any finite number of lanes without deviating from the scope of the present disclosure.

Each of the lanes 407a and 407b may be identified (or defined) by at least two linear features. As used herein, the ‘linear feature’ may be a border (or a boundary) of one particular lane of a link segment (e.g. the link segment 405), a border (or a boundary) of the link segment, and/or a shared border (or a shared boundary) between two lanes of the link segment. For instance, the lane 407a may be identified by the linear features 409 and 411. Similarly, the lane 407b may be identified by the linear features 411 and 413. For instance, the linear features 409 and 413 may correspond to the borders of the link segment 405 (or the borders of the lanes 407a and 407b respectively). For instance, the linear feature 411 may correspond to the shared border between the lanes 407a and 407b. The linear features 409, 411, and 413 may include, but are not limited to, at least one of the lane markings, the guardrails, the road curbs, the road medians, and/or the road barriers.

Some embodiments are based on the realization that the linear features 409, 411, and 413 may be used in vehicle navigation for assisting the one or more vehicles 401 and 403. For instance, the linear features 409, 411, and 413 may be used in lane maintenance application, lane-level maneuvering application, and/or the like. To this end, in some embodiments, the one or more vehicles 401 and 403 may be equipped with various sensors to capture the linear features 409, 411, and 413. For instance, the sensors may include a radar system, a LiDAR system, a global positioning sensor for gathering location data (e.g., GPS), image sensors, temporal information sensors, orientation sensors augmented with height sensors, tilt sensors, and the like. In some example embodiments, the sensors may capture the linear features 409, 411, and 413 as linear feature detections, where each of the linear feature detections corresponds to a portion of one particular linear feature. For instance, each of the linear feature detections may represent image data corresponding to a portion of one particular linear feature.

However, in most of cases, the sensors may fail to accurately capture the linear features 409, 411, and 413, due to noise in the sensors, road geometries, and/or the like. As a result, the linear feature detections captured by the sensors may include false positives. Hereinafter, ‘false positives’ and ‘incorrect linear feature detections’ may be interchangeably used to mean the same. The incorrect linear feature detections may correspond to one or a combination of: (i) linear feature detections with location deviations, (ii) linear feature detections with abnormal orientation, and (iii) linear feature detections that cross two different lanes. For instance, the linear feature detections captured by the sensors may include the linear feature detections with the location deviations, when the sensors capture other markings associated with the link segment 405 as the linear features. For example, the other markings may be linear features (e.g. lane markings) associated with next parallel link segment, markings of parking areas associated the link segment 405, or the like. For instance, the linear feature detections captured by the sensors may include the linear feature detections with the abnormal orientation, when the sensors capture the linear features in the complex road geometries and/or when the sensors correspond to faulty-sensors. For example, the complex road geometries may include a ramp-road geometry, an overpass road geometry, and/or the like. For instance, in the ramp-road geometry, the link segment 405 may be associated with at least one ramp link segment. For instance, in the overpass road geometry, the link segment 405 may be associated with at least one overpass road. For instance, the linear feature detections captured by the sensors may include the linear feature detections that cross two different lanes, when the sensors capture the linear features while the vehicle(s) propagating from one lane to another lane.

Thereby, the linear feature detections captured by the sensors may not be accurate to provide the vehicle navigation. Further, if these inaccurate linear feature detections are used in the vehicle navigation, a vehicle may end-up with unwanted conditions such as entering a wrong lane, road accidents, traffic congestions, vehicle efficiency reduction, environmental pollution, and the like. To this end, the system 101 is provided for filtering the linear feature detections captured by the sensors such that the incorrect linear feature detections are disregarded or discarded. Accordingly, the system 101 may avoid the unwanted conditions. For instance, to filter the linear feature detections, the system 101 may configured as explained in the detailed description of FIG. 4B-FIG. 4E.

FIG. 4B illustrates a schematic diagram 400b showing the linear feature detections associated with the link segment 405, in accordance with one or more example embodiments. FIG. 4B is explained in conjunction with FIG. 4A. As illustrated in FIG. 4B, the schematic diagram 400b may include a plurality of linear feature detections 415a, 415b, 415c, . . . , and 415p, and the link segment 405. According to an embodiment, the system 101 may be configured to obtain vehicle sensor data from the sensors of the one or more vehicles (e.g. the vehicles 401 and 403). In an example embodiment, the vehicle sensor data include the plurality of linear feature detections 415a, 415b, 415c, . . . , and 415p, time stamp data, vehicle location data, lateral position data. The time stamp data may include a time stamp for each of the plurality of linear feature detections 415a, 415b, 415c, . . . , and 415p. As used herein, the time stamp may indicate a time instance at which a particular linear feature detection was recorded by the sensors. The vehicle location data may include a vehicle location for each of the plurality of linear feature detections 415a, 415b, 415c, . . . , and 415p. As used herein, the vehicle location may indicate a location of a vehicle at where a particular linear feature detection was recorded by the sensors. The lateral position data may include a lateral position distance for each of the plurality of linear feature detections 415a, 415b, 415c, . . . , and 415p. As used herein, the lateral position distance may be a distance from the vehicle to a particular linear feature detection recorded by the sensors. In an example embodiment, the lateral position distance may be associated with a sign (e.g., a positive sign or a negative sign). For instance, the lateral position distance with the positive sign may indicate that the particular linear feature detection is located on right side with respect to the vehicle in a direction of travel of the vehicle. Conversely, the lateral position distance with the negative sign may indicate that the particular linear feature detection is located on left side with respect to the vehicle in the direction of travel of the vehicle.

In an embodiment, once the vehicle sensor data is obtained, the system 101 may be configured to identify the link segment 405, using the map data stored in the map database 103a. For instance, the linear feature detection module 301a of the system 101 may identify the link segment 405 by map-matching the vehicle sensor data (specifically, the vehicle location data) with the map data of the map database 103a. In an example embodiment, the link segment 405 may be identified as a vector line (as illustrated in FIG. 4B), when the link segment 405 correspond to the straight road segment. In some embodiments, when the link segment 405 corresponds to other-than-straight road segment (e.g., a curved link segment), the system 101 may extract nodes associated with the link segment 405 and one or more shape locations associated with the link segment 405. Further, the system 101 may identify a plurality of sub-links for the link segment 405, based on the nodes and the one or more shape locations associated with the link segment 405. In an example embodiment, each of the plurality of sub-links may be identified as the vector line such that each vector line is connected to its adjacent vector line to represent the link segment 405.

Further, the system 101 may determine the plurality of linear feature detections 415a, 415b, 415c, . . . , and 415p associated with the link segment 405 by arranging the plurality of linear feature detections 415a, 415b, 415c, . . . , and 415p with respect to the link segment 405 based on the vehicle location data, the time stamp data, and the lateral position data. Accordingly, the system 101 may determine, from the vehicle sensor data, the plurality of linear feature detections 415a, 415b, 415c, . . . , and 415p associated with the link segment 405. For instance, the linear feature detections 415a, 415b, 415c, 415d, 415e, 415f of the plurality of linear feature detections 415a, 415b, 415c, . . . , and 415p may correspond to the linear feature 409. Similarly, the linear feature detections 415g, 415h, 415i, 415j, and 415k and the linear feature detections 415l, 415m, 415n, 415o, and 415p may correspond to the linear features 411 and 413 respectively. Once the plurality of linear feature detections 415a, 415b, 415c, . . . , and 415p are determined, the system 101 may determine orientation data for the plurality of linear feature detections 415a, 415b, 415c, . . . , and 415p. For instance, the linear feature detection module 301a may determine the orientation data for the plurality of linear feature detections 415a, 415b, 415c, . . . , and 415p. In an example embodiment, the orientation data may include an orientation for each of the plurality of linear feature detections 415a, 415b, 415c, . . . , and 415p. For instance, the system 101 may determine the orientation for one particular linear feature detection as explained in the detailed description of FIG. 4C.

FIG. 4C illustrates a schematic diagram 400c for determining an orientation 423, in accordance with one or more example embodiment. FIG. 4C is explained in conjunction with FIG. 4B. As illustrated in FIG. 4C, the schematic diagram 400c may include a pair of adjacent linear feature detections 417a and 417b, a linear feature line 419, a north direction 421, and the orientation 423. The pair of adjacent linear feature detections 417a and 417b may correspond to any pair of adjacent linear feature detections of the plurality of linear feature detections 415a, 415b, 415c, . . . , and 415p. For instance, the pair of adjacent linear feature detections 417a and 417b may correspond to the linear feature detections 415a and 415b. In an example embodiment, the linear feature line 419 may be formed by connecting a first linear feature detection 417a to a second linear feature detection 417b of the pair of adjacent linear feature detections 417a and 417b. In order to determine the orientation 423, the system 101 may determine an angle (also referred to as a heading) between the north direction 421 and the linear feature line 419. Accordingly, the orientation 423 may be the angle between the north direction and the linear feature line 419. Once the orientation 423 is determined, the system 101 may associated the orientation to the first linear feature detection 417a of the pair of adjacent linear feature detections 417a and 417b.

Referring back to FIG. 4B, similarly, the system 101 may determine the orientation for each pair of adjacent linear feature detections of the plurality of linear feature detections 415a, 415b, 415c, . . . , and 415p to determine the orientation data for the plurality of linear feature detections 415a, 415b, 415c, . . . , and 415p. Thereby, each of the plurality of linear feature detections 415a, 415b, 415c, . . . , and 415p may be associated with the respective heading (or the angle) indicative of the orientation.

In some other embodiments, the vehicle sensor data may include the orientation data. The orientation data of the vehicle sensor data may include a driving direction for each of the plurality of linear feature detections 415a, 415b, 415c, . . . , and 415p. For instance, the driving direction may represent a heading in which the vehicle was propagating while recording a particular linear feature detection. For example, the heading may be an angle measured with respect to the north direction or the like. In these embodiments, the orientation of one particular linear feature detection may correspond to the driving direction of the vehicle.

Once the orientation data is determined, the system 101 may be configured to determine the map-based driving direction associated with the link segment 405, using the map data of the map database 103a. For instance, the map-based driving direction determination module 301b may determine, using the map data of the map database 103a, the map-based driving direction associated with the link segment 405. For instance, the map database 103a may separately store the map-based driving direction for the link segment 405 in the link data record corresponding to the link segment 405. For example, the map-based driving direction may correspond to the permitted direction of travel of the vehicle on the link segment 405. In an example embodiment, the map-based driving direction may be an angle between the north direction and the vector line representing the link segment 405.

Further, the system 101 may be configured to compute a heading difference set associated with the plurality of linear feature detections 415a, 415b, 415c, . . . , and 415p, based on the map-based driving direction. For instance, the heading difference computation module 301c may be configured to compute the heading difference set associated with the plurality of linear feature detections 415a, 415b, 415c, . . . , and 415p, based on the map-based driving direction. In an example embodiment, to determine the heading difference set, the system 101 may be configured to determine an angular difference between (i) the map-based driving direction and (ii) the heading associated with each of the plurality of linear feature detections 415a, 415b, 415c, . . . , and 415p. Accordingly, each heading difference of the heading difference set respectively comprises the angular difference between the map-based driving direction and the respective heading of one of the plurality of linear feature detections 415a, 415b, 415c, . . . , and 415p. For instance, the angular difference between the map-based driving direction and the heading of one particular linear feature detection may be an absolute value of difference between the map-based driving direction and the heading of one particular linear feature detection.

Furthermore, the system 101 may be configured to filter the plurality of linear feature detections 415a, 415b, 415c, . . . , and 415p, based on the computed heading difference set. For instance, the filtering module 301d may be configured to filter the plurality of linear feature detections 415a, 415b, 415c, . . . , and 415p, based on the computed heading difference set. In an embodiment, to filter the plurality of linear feature detections 415a, 415b, 415c, . . . , and 415p, the system 101 may execute a comparison criterion. For instance, when the comparison criterion is executed, the system 101 may be configured to compare each heading difference of the heading difference set with a heading difference threshold value for filtering the plurality of linear feature detections 415a, 415b, 415c, . . . , and 415p. Accordingly, in this embodiment, the system 101 may filter the plurality of linear feature detections 415a, 415b, 415c, . . . , and 415p, based on the computed heading difference set and the comparison criterion. For instance, based on the computed heading difference set and the comparison criterion, the system 101 may filter the plurality of linear feature detections 415a, 415b, 415c, . . . , and 415p as explained in the detailed description of FIG. 4D.

FIG. 4D illustrates a flowchart 400d for filtering the plurality of linear feature detections 415a, 415b, 415c, . . . , and 415p based on the heading difference set and the comparison criterion, in accordance with one or more example embodiments. FIG. 4D is explained in conjunction with FIG. 4A and FIG. 4B. The flowchart 400d may be executed by the system 101 (e.g. the filtering module 301d). Starting at step 425a, the system 101 may select, from the heading difference set, a first heading difference associated with a first linear feature detection of the plurality of linear feature detections 415a, 415b, 415c, . . . , and 415p. For instance, the system 101 may select the heading difference computed between the map-based driving direction and the heading associated with the linear feature detection 415a as the first heading difference. At step 425b, the system 101 may check if the first heading difference is greater than a heading difference threshold value. The heading difference threshold value may be pre-determined based on experimentations and/or the like. For instance, the heading difference threshold value may be numerically equal to ten degrees. If the first heading difference is greater than the heading difference threshold value, the system 101 may proceed with step 425c.

At step 425c, the system 101 may identify the first linear feature detection as the incorrect linear feature detection. For instance, the first linear feature detection may be identified as the incorrect linear feature detection with the abnormal orientation, if the first heading difference is greater than the heading difference threshold value. At step 425d, the system 101 may discard or disregard the first linear feature detection from the plurality of linear feature detections 415a, 415b, 415c, . . . , and 415p. For instance, in one embodiment, the system 101 may remove (i.e., discard) the first linear feature detection from the plurality of linear feature detections 415a, 415b, 415c, . . . , and 415p. In another embodiment, the system 101 may not consider the first linear feature detection of the plurality of linear feature detections 415a, 415b, 415c, . . . , and 415p for further processing such as providing the vehicle navigation.

If the first heading difference is not greater than the heading difference threshold value, the system 101 may proceed with step 425e. At step 425e, the system 101 may check if a second linear feature detection exists in the plurality of linear feature detections 415a, 415b, 415c, . . . , and 415p. For instance, the second linear feature detection may correspond to the linear feature detection 415b of the plurality of linear feature detections 415a, 415b, 415c, . . . , and 415p. If the second linear feature detection exists, the system 101 may proceed with step 425f. At step 425f, the system 101 may select, from the heading difference set, a second heading difference associated with the second linear feature detection. For instance, the system 101 may select the heading difference computed between the map-based driving direction and the heading associated with the linear feature detection 415b as the second heading difference. Further, the system 101 may proceed with step 425b to check if the second heading difference is greater than the heading difference threshold.

In this way, the system 101 may iteratively execute the steps of the flowchart 400d for each of plurality of linear feature detections 415a, 415b, 415c, . . . , and 415p to determine at least one linear feature detection from the plurality of linear feature detections 415a, 415b, 415c, . . . , and 415p such that the at least one linear feature detection is associated the heading difference that is greater than the heading difference threshold value. For instance, the system 101 may determine the linear feature detections 415b, 415c, and 415d from the plurality of linear feature detections 415a, 415b, 415c, . . . , and 415p, since each of the linear feature detections 415b, 415c, and 415d is associated with the heading difference that is greater than the heading difference threshold value. Further, the system 101 may identify the linear feature detections 415b, 415c, and 415d as the incorrect linear feature detections. For instance, the linear feature detections 415b, 415c, and 415d may be identified as the incorrect linear feature detections with the abnormal orientations. Furthermore, the system 101 may discard or disregard the linear feature detections 415b, 415c, and 415d from the plurality of linear feature detections for providing the vehicle navigation. Thereby, the system 101 may avoid the unwanted conditions. In some embodiments, the system 101 may also remove one or more linear feature lines formed between the linear feature detections 415b, 415c, and 415d. Further, the system 101 may use the linear feature detections 415a, 41e, 415f, 415g, 415h, 415i, 415j, 415k, 415l, 415m, 415o, 415p to update the map data of the map database 103a. Furthermore, the system 101 may generate one or more navigation functions for the vehicle using the updated map database 103a and/or the linear feature detections 415a, 41e, 415f, 415g, 415h, 415i, 415j, 415k, 415l, 415m, 415o, 415p. Some non-limiting examples of the navigation functions includes providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

Referring back to FIG. 4B, in another embodiment, the system 101 may execute a clustering criterion to filter the plurality of linear feature detections 415a, 415b, 415c, . . . , and 415p. For instance, when the clustering criterion is executed, the system 101 may be configured to generate two or more heading difference clusters based on the heading difference set; and filter the plurality of linear feature detections 415a, 415b, 415c, . . . , and 415p based on the generated two or more heading difference clusters. Accordingly, in this embodiment, the system 101 may filter the plurality of linear feature detections 415a, 415b, 415c, . . . , and 415p, based on the clustering criterion and the heading difference set. For instance, based on the clustering criterion and the heading difference set, the system 101 may filter the plurality of linear feature detections 415a, 415b, 415c, . . . , and 415p as explained in the detailed description of FIG. 4E.

FIG. 4E illustrates a graphical representation 400e for filtering the plurality of linear feature detections 415a, 415b, 415c, . . . , and 415p based on the heading difference set and the clustering criterion, in accordance with one or more example embodiments. FIG. 4E is explained in conjunction with FIG. 4A and FIG. 4B. The graphical representation 400e shows two or more heading difference clusters 427, 429, 431, 433, 435, and 437. The x-axis of the graphical representation 400e corresponds to the heading differences between the map-based driving direction and the headings associated with the plurality of linear feature detections 415a, 415b, 415c, . . . , and 415p. The y-axis of the graphical representation 400e corresponds to a frequency that is indicative of a number of identical heading differences in one particular heading difference cluster.

For instance, the two or more heading difference clusters 427, 429, 431, 433, 435, and 437 may be generated by the system 101 upon executing the clustering criterion. For example, when the system 101 executes the clustering criterion, the system 101 may be configured to cluster one or more identical heading differences of the heading difference set into one particular heading difference cluster to generate the two or more heading difference clusters 427, 429, 431, 433, 435, and 437. In other words, if the one or more heading difference values of the heading difference set are identical, then the one or more heading difference values may be clustered into one particular heading difference cluster. For instance, the heading differences associated with the linear feature clusters 415g, 415h, 415i, 415j, and 415k may be identical, accordingly the system 101 may cluster the heading differences associated with the linear feature clusters 415g, 415h, 415i, 415j, and 415k into the heading difference cluster 427. Further, the heading differences associated with the linear feature detections 415l, 415m, 415n, 415o, and 415p may be identical, accordingly the system 101 may cluster the heading differences associated with the linear feature clusters 415l, 415m, 415n, 415o, and 415p into the heading difference cluster 429. Furthermore, the heading differences associated with the linear feature detection 415a, 415e, and 415f may be identical, accordingly the system 101 may cluster the heading differences associated with the linear feature clusters 415a, 415e, and 415f into the heading difference cluster 431. Furthermore, the heading difference associated the linear feature 415b may not match with any other heading difference in the heading difference set, accordingly the system 101 may cluster the heading difference associated the linear feature 415b into the heading difference cluster 433. Furthermore, the heading difference associated the linear feature 415c may not match with any other heading difference in the heading difference set, accordingly the system 101 may cluster the heading difference associated the linear feature 415c into the heading difference cluster 435. Furthermore, the heading difference associated the linear feature 415d may not match any other heading difference in the heading difference set, accordingly the system 101 may cluster the heading difference associated the linear feature 415d into the heading difference cluster 437. Thereby, each of the generated one or more heading difference cluster 427, 429, 431, 433, 435, and 437 may include the one or more identical heading differences of the heading difference set.

In an embodiment, based on the generated two or more heading difference clusters 427, 429, 431, 433, 435, and 437 are generated, the system 101 identify an outlier cluster within the generated two or more heading difference clusters 427, 429, 431, 433, 435, and 437. For instance, the system 101 identify a heading difference cluster as the outlier cluster, if (i) the heading difference cluster has a least (or lower) frequency among the two or more heading difference clusters 427, 429, 431, 433, 435, and 437 and/or (ii) the heading difference cluster has the one or more identical heading difference values that are maximum among the two or more heading difference clusters 427, 429, 431, 433, 435, and 437. For example, the system 101 may identify the heading difference clusters 433, 435, 437 as the outlier clusters. Further, up on identifying the heading difference clusters 433, 435, 437 as the outlier clusters, the system 101 may determine a respective heading difference computed for a particular one of the plurality of linear feature detection as an outlier in relative to other heading differences of the heading difference set. For instance, the system 101 may determine the heading difference of the linear feature detection 415b as the outlier, since the heading difference of the linear of the linear feature detection 415b is associated with the identified heading difference cluster 433 that has the least frequency and/or the maximum heading difference value among the two or more heading difference clusters 427, 429, 431, 433, 435, and 437. Similarly, the system 101 may determine the heading difference of the linear feature detections 415c and 415d as the outliers.

Further, the system 101 identify at least one outlier liner feature detection from the plurality of linear feature detections, based on the determined outlier clusters 433, 435, 437. For instance, the system 101 may identify the linear feature detections 415b, 415c, and 415d as the outlier linear feature detections, since the heading differences of the linear feature detections 415b, 415c, and 415d are associated with the outlier clusters 433, 435, and 437 respectively. Furthermore, the system 101 may identify the outlier linear feature detections 415b, 415c, and 415d as the incorrect linear feature detections. For instance, the outlier linear feature detections 415b, 415c, and 415d may be identified as the incorrect linear feature detections with the abnormal orientations. Furthermore, the system 101 may discard or disregard the outlier linear feature detections 415b, 415c, and 415d from the plurality of linear feature detections for further processing such as providing the vehicle navigation. Thereby, the system 101 may avoid the unwanted conditions. Further, the system 101 may use the linear feature detections 415a, 41e, 415f, 415g, 415h, 415i, 415j, 415k, 415l, 415m, 415o, 415p to update the map data of the map database 103a. Furthermore, the system 101 may generate one or more navigation functions for the vehicle using the updated map database 103a and/or the linear feature detections 415a, 41e, 415f, 415g, 415h, 415i, 415j, 415k, 415l, 415m, 415o, 415p. Some non-limiting examples of the navigation functions includes providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

For purpose of explanation, in FIG. 4A-4E, the link segment 405 of straight road segment is considered. In some cases, the link segment 405 may be other-than-straight road segment. In these cases, the link segment 405 may be represented by the plurality of vector lines. Accordingly, a first map-based driving direction associated one vector line of the plurality of vector lines may not be equal to a second map-based driving direction associated another vector line of the plurality of vector line. Thereby, the heading differences associated with the linear feature detections representing one particular linear feature may also vary. In these situations, filtering the plurality of linear feature detections based on the heading difference set and the clustering criterion may be beneficial, because in the clustering criterion the one or more heading differences of each heading difference cluster is compared against the one or more heading differences of each other heading difference clusters. Accordingly, even if the heading differences associated with the linear feature detections representing one particular linear feature varies, the identification of the incorrect linear feature detections (i.e. the outlier linear feature detections) may not be affected. Thereby, the system 101 may accurately identify the incorrect linear feature detections for filtering, even if the link segment 405 corresponds to the other-than-straight road segment.

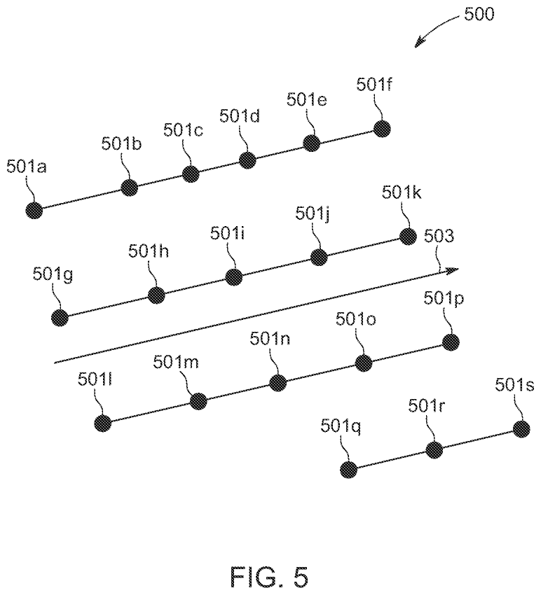

For exemplary purpose, in FIG. 4A-4E, the plurality of linear feature detections including the incorrect linear feature detections with abnormal orientations is considered. In some cases, the plurality of linear feature detections may further include the incorrect linear feature detection with location deviations. For instance, when the plurality of linear feature detections includes the incorrect linear feature detection with the location deviations, the system 101 may be configured to as explained in the detailed description of FIG. 5.

FIG. 5 illustrates a schematic diagram 500 showing the linear feature detections that include the incorrect linear feature detections with location deviations, in accordance with one or more example embodiments. FIG. 5 is explained in conjunction with FIG. 4A. As illustrated in FIG. 5, the schematic diagram 500 may include a plurality of linear feature detections 501a, 501b, 501c, . . . , and 501s and a link segment 503. For instance, the link segment 503 may correspond to the link segment 405. For instance, the linear feature detections 501a, 501b, 501c, 501d, 501e, and 501f may correspond to the linear feature 409. Further, the linear feature detections 501g, 501h, 501i, 501j, and 501k may correspond to the linear feature 411. Furthermore, the linear feature detections 5011, 501m, 501n, 501o, and 501p may correspond to the linear feature 413. Furthermore, the linear feature detections 501q, 501r and 501s may correspond to the markings of the next parallel link segment, markings of the parking areas or the like. In an example embodiment, the linear feature detections 501q, 501r, and 501s may be the incorrect linear feature detections with the location deviations. In an example embodiment, the system 101 determine, from the vehicle sensor data, the plurality of linear feature detections 501a, 501b, 501c, . . . , and 501s associated with the link segment 503. For instance, the system 101 may determine, from the vehicle sensor data, the plurality of linear feature detections 501a, 501b, 501c, . . . , and 501s as explained in the detailed description of FIG. 4B.

In FIG. 5, for exemplary purpose, the plurality of linear feature detections 501a, 501b, 501c, . . . , and 501s including the incorrect linear feature detections with the location deviations is considered. In some cases, the plurality of linear feature detections 501a, 501b, 501c, . . . , and 501s may also include the incorrect linear feature detections with the abnormal orientations, as illustrated in FIG. 4B. In these cases, the system 101 may filter the plurality of linear feature detections 501a, 501b, 501c, . . . , and 501s such that the incorrect linear feature detections with the abnormal orientations are disregarded or discarded. For instance, the system 101 may filter the plurality of linear feature detections 501a, 501b, 501c, . . . , and 501s as explained in the detailed description of FIG. 4B-4E.

Additionally or alternatively, to discard or disregard the linear feature detections 501q, 501r and 501s from the plurality of linear feature detections 501a, 501b, 501c, . . . , and 501s, the system 101 may determine a distance set, based on the plurality of linear feature detections 501a, 501b, 501c, . . . , and 501s. In an example embodiment, to determine the distance set, the system 101 may compute a distance between the link segment 503 and each of the plurality of linear feature detections 501a, 501b, 501c, . . . , and 501s. Accordingly, a given distance of the distance set respectively comprises the distance between the link segment 503 and a respective linear feature detection of the plurality of linear feature detections 501a, 501b, 501c, . . . , and 501s.

Further, the system 101 may filter the plurality of linear feature detections 501a, 501b, 501c, . . . , and 501s, based on the determined distance set. In an example embodiment, to filter the plurality of linear feature detections 501a, 501b, 501c, . . . , and 501s based on the determined distance set, the system 101 may be configured to check if at least one distance of the distance set is greater than a distance threshold value. For instance, the system 101 may check if the at least one distance of the distance set is greater than the distance threshold value, by comparing each distance of the distance set with the distance threshold value. The distance threshold value may be predetermined threshold value. For instance, the distance threshold value may be half of lane-counts multiplied by a lane-width plus a buffer. For example, the distance threshold value may be numerically equal to: (N/2×w)+b, where the notation ‘N’ indicates a total number of lanes on the link segment 503, the notation ‘w’ indicates the lane-width, the notation ‘b’ indicates the buffer that corresponds to a road-side parking width.

Upon determining the at least one distance of the distance set is greater than the distance threshold value, the system 101 may identify, from the plurality of linear feature detections 501a, 501b, 501c, . . . , and 501s, at least one linear feature detection that is associated with the at least one distance as the incorrect linear feature detection with location deviation. For instance, the system 101 may identify the linear feature detections 501q, 501r, and 501s as the incorrect linear feature detection with location deviation, since the distance associated with each of the linear feature detections 501q, 501r, and 501s may be greater than the distance threshold value.

Furthermore, the system 101 may discard or disregard the identified at least one linear feature detection from the plurality of linear feature detections 501a, 501b, 501c, . . . , and 501s. For instance, in one embodiment, the system 101 may remove the identified at least one linear feature detection (e.g., the linear feature detections 501q, 501r, and 501s) from the plurality of linear feature detections 501a, 501b, 501c, . . . , and 501s. In another embodiment, the system 101 may not consider the identified at least one linear feature detection of the plurality of linear feature detections 501a, 501b, 501c, . . . , and 501s for further processing, such as providing the vehicle navigation and/or updating the map data of the map database 103a. Thereby, the system 101 may avoid the unwanted conditions. Furthermore, the system 101 may use the linear feature detections 501a, 501b, 501c, . . . , and 501p to update the map data of the map database 103a. Furthermore, the system 101 may generate one or more navigation functions for the vehicle using the updated map database 103a and/or the linear feature detections 501a, 501b, 501c, . . . , and 501p.

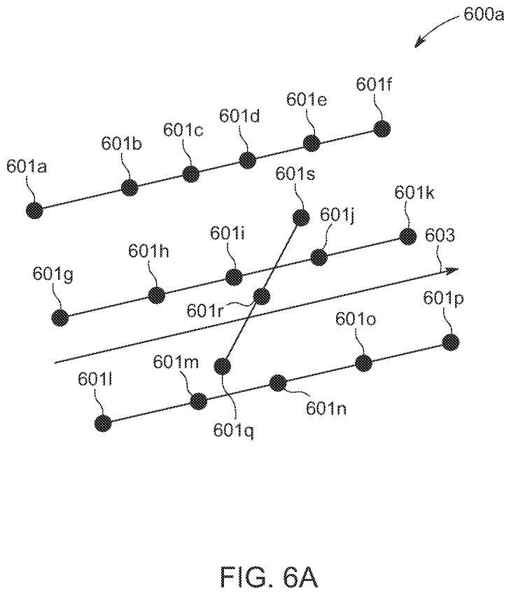

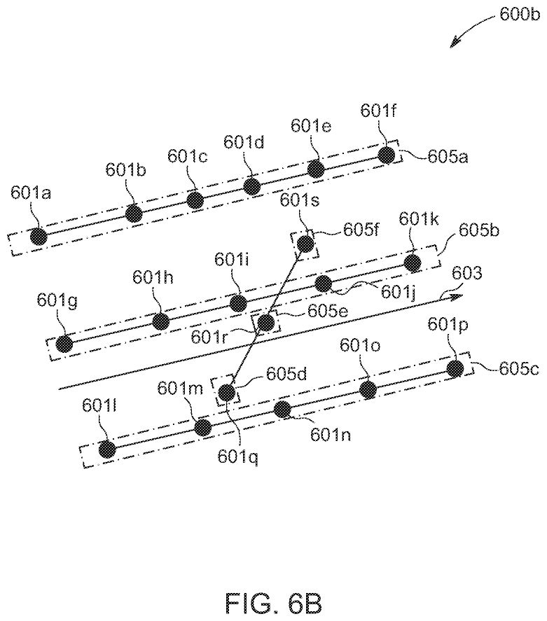

In some cases, the plurality of linear feature detections 501a, 501b, 501c, . . . , 501s may further include the incorrect linear feature detection that cross two different lanes. In these cases, the system 101 may be configured as explained in the detailed description of FIG. 6A-6B.

FIG. 6A illustrates a schematic diagram 600a showing the linear feature detections that include the incorrect linear feature detections crossing two different lanes, in accordance with one or more example embodiments. FIG. 6A is explained in conjunction with FIG. 4A. As illustrated in FIG. 6A, the schematic diagram 600a may include a plurality of linear feature detections 601a, 601b, 601c, . . . , and 601s and a link segment 603. For instance, the link segment 603 may correspond to the link segment 405. For instance, the linear feature detections 601a, 601b, 601c, 601d, 601e, and 601f may correspond to the linear feature 409. Further, the linear feature detections 601g, 601h, 601i, 601j, and 601k may correspond to the linear feature 411. Furthermore, the linear feature detections 6011, 601m, 601n, 601o, and 601p may correspond to the linear feature 413. Furthermore, the linear feature detections 601q, 601r and 601s may correspond to the incorrect linear feature detections crossing two different lanes. In an example embodiment, the system 101 determine, from the vehicle sensor data, the plurality of linear feature detections 601a, 601b, 601c, . . . , and 601s associated with the link segment 603. For instance, the system 101 may determine, from the vehicle sensor data, the plurality of linear feature detections 601a, 601b, 601c, . . . , and 601s as explained in the detailed description of FIG. 4B.

In FIG. 6A, for exemplary purpose, the plurality of linear feature detections 601a, 601b, 601c, . . . , and 601s including the incorrect linear feature detections crossing two different lanes is considered. In some cases, the plurality of linear feature detections 601a, 601b, 601c, . . . , and 601s may further include the incorrect linear feature detections with the abnormal orientations, as illustrated in FIG. 4B. In these cases, the system 101 may filter the plurality of linear feature detections 601a, 601b, 601c, . . . , and 601s such that the incorrect linear feature detections with the abnormal orientations are disregarded or discarded. For instance, the system 101 may filter the plurality of linear feature detections 601a, 601b, 601c, . . . , and 601s as explained in the detailed description of FIG. 4B-4E. Furthermore, in certain scenarios, the plurality of linear feature detections 601a, 601b, 601c, . . . , and 601s may further include the incorrect linear feature detections with the location deviations. In these scenarios, the system 101 may filter the plurality of linear feature detections 601a, 601b, 601c, . . . , and 601s such that the incorrect linear feature detections with the location deviations are disregarded or discarded. For instance, the system 101 may filter the plurality of linear feature detections 601a, 601b, 601c, . . . , and 601s as explained in the detailed description of FIG. 5.

Further, in an example embodiment, the system 101 may determine the distance set for the plurality of linear feature detections 601a, 601b, 601c, . . . , and 601s such that each element of the distance set corresponds to the distance between the link segment 603 and a respective linear feature detection of the plurality of linear feature detections 601a, 601b, 601c, . . . , and 601s. For instance, the system 101 may determine the distance set for the plurality of linear feature detections 601a, 601b, 601c, . . . , and 601s as explained in the detailed description of FIG. 5.

Additionally or alternatively, to discard or disregard the linear feature detections 601q, 601r, and 601s from the plurality of linear feature detections 601a, 601b, 601c, . . . , and 601s, the system 101 may be configured to generate one or more distance clusters. For instance, the system 101 may generate the one or more distance clusters as explained in the detailed description of FIG. 6B.

FIG. 6B illustrates a schematic diagram 600b for generating one or more distance clusters 605a, 605b, 605c, 605d, 605e, and 605f, in accordance with one or more example embodiments. The schematic diagram 600b may include the plurality of linear feature detections 601a, 601b, and 601s, the link segment 603, and the one or more distance clusters 605a, 605b, 605c, 605d, 605e, and 605f In an embodiment, the system 101 may generate the one or more distance clusters 605a, 605b, 605c, 605d, 605e, and 605f, based on the distance set. In an example embodiment, to generate the one or more distance clusters 605a, 605b, 605c, 605d, 605e, and 605f, the system 101 may be configured to cluster one or more linear feature detections into one particular distance cluster, if the distances associated with each of the one or more linear feature clusters are identical. For instance, since the distances from the link segment 603 to the linear feature detections 601a, 601b, 601c, 601d, 601e, and 601f are identical, the system 101 may cluster the linear feature detections 601a, 601b, 601c, 601d, 601e, and 601f into the distance cluster 605a. Further, since the distances from the link segment 603 to the linear feature detections 601g, 601h, 601i, 601j, and 601k are identical, the system 101 may cluster the linear feature detections 601g, 601h, 601i, 601j, and 601k into the distance cluster 605b. Furthermore, since the distances from the link segment 603 to the linear feature detections 6011, 601m, 601n, 601o, and 601p are identical, the system 101 may cluster the linear feature detections 6011, 601m, 601n, 601o, and 601p into the distance cluster 605c. Furthermore, since the distance from the link segment 603 and the linear feature detection 601q does not match any other distance in the distance set, the system 101 may cluster the linear feature detection 601q into the distance cluster 605d. Furthermore, since the distance from the link segment 603 and the linear feature detection 601r does not match any other distance in the distance set, the system 101 may cluster the linear feature detection 601r into the distance cluster 605e. Furthermore, since the distance from the link segment 603 and the linear feature detection 601s does not match any other distance in the distance set, the system 101 may cluster the linear feature detection 601s into the distance cluster 605f. Thereby, each distance cluster of the one or more distance clusters 605a, 605b, 605c, 605d, 605e, and 605f may include one or more linear feature detections of the plurality of linear feature detections 601a, 601b, . . . , and 601s with the identical distances.

Furthermore, the system 101 may be configured to filter the plurality of linear feature detections 601a, 601b, . . . , and 601s based on the generated one or more distance clusters 605a, 605b, 605c, 605d, 605e, and 605f. In an example embodiment, to filter the plurality of linear feature detections 601a, 601b, . . . , and 601s, the system 101 may identify at least one pair of adjacent linear feature detections from the plurality of linear feature detections 601a, 601b, . . . , and 601s such that one linear feature detection of the identified at least one pair of adjacent linear feature detections is associated with a first distance cluster and another linear feature detection of the identified at least one pair of adjacent linear feature detections is associated with a second distance cluster. For instance, the system 101 may identify the at least one pair of adjacent linear feature detections from the plurality of linear feature detections 601a, 601b, . . . , and 601s by checking, for each pair of adjacent linear feature detection in the plurality of linear feature detections 601a, 601b, . . . , and 601s, whether a first linear feature detection of the pair is associated with the first distance cluster and a second linear feature detection of the pair is associated with the second distance. For instance, the first distance cluster may correspond to any one of the generated one or more distance clusters 605a, 605b, 605c, 605d, 605e, and 605f. The second distance cluster may be different from the first cluster and may correspond to one of the generated one or more distance clusters 605a, 605b, 605c, 605d, 605e, and 605f. For instance, since the adjacent linear feature detections 601q and 601r are associated with two different distance clusters, the system 101 may identify the adjacent linear feature detections 601q and 601r as the incorrect linear feature detections crossing two different lanes. Further, since the adjacent linear feature detections 601r and 601s are associated with two different distance clusters, the system 101 may identify the adjacent linear feature detections 601r and 601s as the incorrect linear feature detections crossing two different lanes.

Furthermore, the system 101 may discard or disregard the identified at least one pair of adjacent linear feature detections from the plurality of linear feature detections 601a, 601b, 601c, . . . , 601s. For instance, in one embodiment, the system 101 may remove the identified at least one pair of adjacent linear feature detections (e.g. the linear feature detection 601q, 601r, and 601s) from the plurality of linear feature detections 601a, 601b, 601c, . . . , 601s. In another embodiment, the system 101 may not consider the identified at least one pair of adjacent linear feature detections of the plurality of linear feature detections 601a, 601b, 601c, . . . , 601s for further processing such as providing the vehicle navigation and/or updating the map data of the map database 103a. Thereby, the system 101 may avoid the unwanted conditions. Furthermore, the system 101 may use the linear feature detections 601a, 601b, 601c, . . . , and 601p to update the map data of the map database 103a. Furthermore, the system 101 may generate one or more navigation functions for the vehicle using the updated map database 103a and/or the linear feature detections 601a, 601b, 601c, . . . , and 601p.

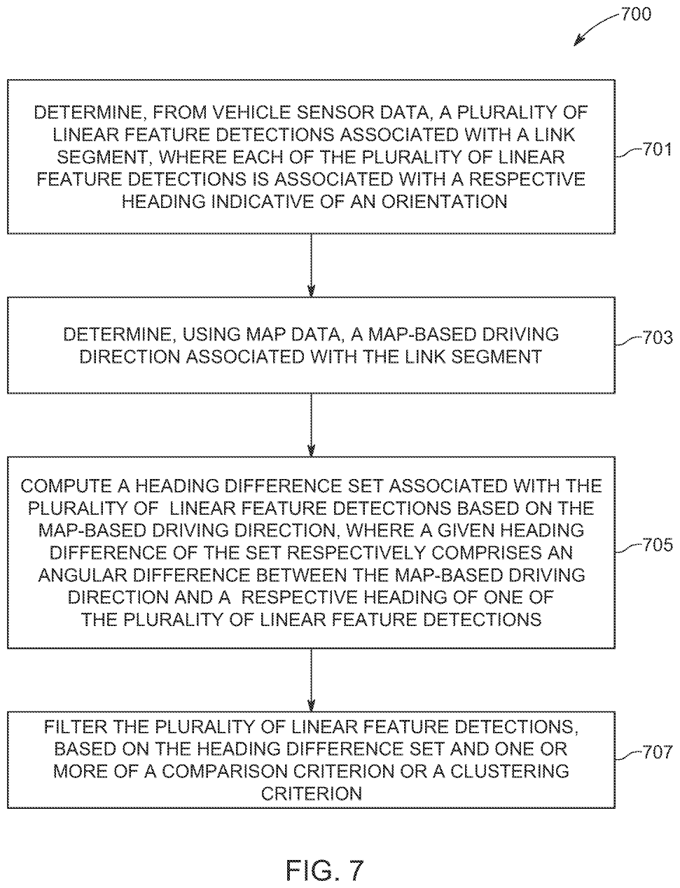

FIG. 7 illustrates a flowchart depicting a method 700 for filter the plurality of linear feature detections, in accordance with one or more example embodiments. It will be understood that each block of the flow diagram of the method 700 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 303 of the system 101, employing an embodiment of the present invention and executed by the processor 301. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow chart support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

Starting at block 701, the method 700 may include determining, from the vehicle sensor data, the plurality of linear feature detections associated with the link segment. For example, the linear feature detection module 301a may determine, from the vehicle sensor data, the plurality of linear feature detections 415a, 415b, 415c, . . . , and 415p associated with the link segment 405 as explained in the detailed description of FIG. 4B. In an example embodiment, each of the plurality of linear feature detections may be associated with the respective heading indicative of the orientation.

At block 703, the method 700 may include determining, using the map data, the map-based driving direction associated with the link segment. For example, the map-based driving direction determination module 301b may determine, using the map data, the map-based driving direction associated with the link segment 405.

At step 705, the method 700 may include computing the heading difference set associated with the plurality of linear feature detections, based on the map-based driving direction. For example, the heading difference module 301c may compute, based on the map-based driving direction, the heading difference set associated with the plurality of linear feature detections 415a, 415b, 415c, . . . , and 415p such that a given heading difference of the set respectively comprises the angular difference between the map-based driving direction and the respective heading of one of the plurality of linear feature detections 415a, 415b, 415c, . . . , and 415p.

At step 707, the method 700 may include filtering the plurality of linear feature detections, based on the heading difference set and one or more of the comparison criterion or the clustering criterion. For example, the filtering module 301d may filter the plurality of linear feature detections 415a, 415b, 415c, . . . , and 415p, based on the heading difference set and one or more of the comparison criterion or the clustering criterion.

On implementing the method 700 disclosed herein, the system 101 may be configured to filter the plurality of linear feature detections such that the incorrect linear feature detections are discarded or disregarded for providing the vehicle navigation. Thereby, the system 101 may avoid the unwanted conditions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for filtering a plurality of linear feature detections, the system comprising:
a memory configured to store computer-executable instructions; and
at least one processor configured to execute the computer-executable instructions to:
determine, from vehicle sensor data, the plurality of linear feature detections associated with a link segment, wherein each of the plurality of linear feature detections is associated with a respective heading indicative of an orientation;
determine, using map data, a map-based driving direction associated with the link segment;
based on the map-based driving direction, compute a heading difference set associated with the plurality of linear feature detections, wherein a given heading difference of the set respectively comprises an angular difference between the map-based driving direction and a respective heading of one of the plurality of linear feature detections; and
filter the plurality of linear feature detections based on (i) the heading difference set, and (ii) one or more of a comparison criterion or a clustering criterion.

2. The system of claim 1, wherein filtering based on the heading difference set and the clustering criterion comprises:
determining that a respective heading difference computed for a particular one of the plurality of linear feature detections is an outlier relative to other heading differences of the set; and
based on the respective heading difference computed for the particular linear feature detection being an outlier relative to other heading differences of the set, discarding or disregarding the particular linear feature detection.

3. The system of claim 2, wherein determining that the respective heading difference computed for the particular one of the plurality of linear feature detections is the outlier relative to other heading differences of the set comprises:
generating two or more heading difference clusters based on the heading difference set, wherein a given heading difference cluster comprises one or more identical heading differences;
identifying an outlier cluster within the generated two or more heading difference clusters; and
determining that the respective heading difference computed for the particular linear feature detection is associated with the identified outlier cluster.

4. The system of claim 1, wherein filtering based on the heading difference set and the comparison criterion comprises:
determining that a respective heading difference computed for a particular one of the plurality of linear feature detections is greater than a heading difference threshold value; and
based on the respective heading difference computed for the particular linear feature detection being greater than the heading difference threshold value, discarding or disregarding the particular linear feature detection.

5. The system of claim 1, wherein the at least one processor is further configured to:
determine a distance set based on the plurality of linear feature detections, wherein a given distance of the distance set respectively comprises a distance between the link segment and a respective linear feature detection of the plurality of linear feature detections; and
filter the plurality of linear feature detections, based on the distance set.

6. The system of claim 5, wherein filtering based on the distance set comprises discarding or disregarding at least one linear feature detection from the plurality of linear feature detections, when at least one distance corresponding to the at least one linear feature detection is greater than a distance threshold value.

7. The system of claim 5, wherein the at least one processor is further configured to:
generate one or more distance clusters based on the distance set, wherein a given distance cluster comprises one or more linear feature detections of the plurality of linear feature detections with identical distances; and
filter the plurality of linear feature detections, based on the generated one or more distance clusters.

8. The system of claim 7, wherein filtering based on the generated one or more distance clusters comprises:
identifying at least one pair of adjacent linear feature detections from the plurality of linear feature detections, based on the generated one or more distance clusters, wherein one linear feature detection of the identified at least one pair of adjacent linear feature detections is associated with a first distance cluster and another linear feature detection of the identified at least one pair of adjacent linear feature detections is associated with a second distance cluster; and
discarding or disregarding the identified at least one pair of adjacent linear feature detections from the plurality of linear feature detections.

9. A method for filtering a plurality of linear feature detections, the method comprising:
determining, from vehicle sensor data, the plurality of linear feature detections associated with a link segment, wherein each of the plurality of linear feature detections is associated with a respective heading indicative of an orientation;
determining, using map data, a map-based driving direction associated with the link segment;
computing a heading difference set associated with the plurality of linear feature detections, based on the map-based driving direction, wherein a given heading difference of the set respectively comprises an angular difference between the map-based driving direction and a respective heading of one of the plurality of linear feature detections;
determining a distance set based on the plurality of linear feature detections, wherein a given distance of the distance set respectively comprises a distance between the link segment and a respective linear feature detection of the plurality of linear feature detections;
generating one or more distance clusters based on the distance set, wherein a given distance cluster comprises one or more linear feature detections of the plurality of linear feature detections with identical distances; and
filtering the plurality of linear feature detections, based on one or a combination of the heading difference set and the generated one or more distance clusters.

10. The method of claim 9, wherein filtering based on the heading difference set comprises:
determining that a respective heading difference computed for a particular one of the plurality of linear feature detections is an outlier relative to other heading differences of the set; and
based on the respective heading difference computed for the particular linear feature detection being an outlier relative to other heading differences of the set, discarding or disregarding the particular linear feature detection.

11. The method of claim 10, wherein determining that the respective heading difference computed for the particular one of the plurality of linear feature detections is the outlier relative to other heading differences of the set comprises:
generating two or more heading difference clusters based on the heading difference set, wherein a given heading difference cluster comprises one or more identical heading differences;
identifying an outlier cluster within the generated two or more heading difference clusters; and
determining that the respective heading difference computed for the particular linear feature detection is associated with the identified outlier cluster.

12. The method of claim 9, wherein filtering based on the heading difference set comprises:
determining that a respective heading difference computed for a particular one of the plurality of linear feature detections is greater than a heading difference threshold value; and
based on the respective heading difference computed for the particular linear feature detection being greater than the heading difference threshold value, discarding or disregarding the particular linear feature detection.

13. The method of claim 9, wherein filtering based on the generated one or more distance clusters comprises:
identifying at least one pair of adjacent linear feature detections from the plurality of linear feature detections, based on the generated one or more distance clusters, wherein one linear feature detection of the identified at least one pair of adjacent linear feature detections is associated with a first distance cluster and another linear feature detection of the identified at least one pair of adjacent linear feature detections is associated with a second distance cluster; and
discarding or disregarding the identified at least one pair of adjacent linear feature detections from the plurality of linear feature detections.

14. The method of claim 9, further comprising filtering the plurality of linear feature detections, based on the distance set, wherein filtering based on the distance set comprises discarding or disregarding at least one linear feature detection from the plurality of linear feature detections, when at least one distance corresponding to the at least one linear feature detection is greater than a distance threshold value.

15. A computer program product comprising a non-transitory computer readable medium having stored thereon computer executable instruction which when executed by at least one processor, cause the at least one processor to carry out operations for filtering a plurality of linear feature detections, the operation comprising:
determining, from vehicle sensor data, the plurality of linear feature detections associated with a link segment, wherein each of the plurality of linear feature detections is associated with a respective heading indicative of an orientation;
determining, using map data, a map-based driving direction associated with the link segment;
computing a heading difference set associated with the plurality of linear feature detections, based on the map-based driving direction, wherein a given heading difference of the set respectively comprises an angular difference between the map-based driving direction and a respective heading of one of the plurality of linear feature detections;
determining a distance set based on the plurality of linear feature detections, wherein a given distance of the distance set respectively comprises a distance between the link segment and a respective linear feature detection of the plurality of linear feature detections;
generating one or more distance clusters based on the distance set, wherein a given distance cluster comprises one or more linear feature detections of the plurality of linear feature detections with identical distances; and
filtering the plurality of linear feature detections, based on one or a combination of the heading difference set, the distance set, and the generated one or more distance clusters.

16. The computer program product of claim 15, wherein for filtering based on the heading difference set, the operations further comprise:
determining that a respective heading difference computed for a particular one of the plurality of linear feature detections is an outlier relative to other heading differences of the set; and
based on the respective heading difference computed for the particular linear feature detection being an outlier relative to other heading differences of the set, discarding or disregarding the particular linear feature detection.

17. The computer program product of claim 16, wherein determining that the respective heading difference computed for the particular one of the plurality of linear feature detections is the outlier relative to other heading differences of the set comprises:
generating two or more heading difference clusters based on the heading difference set, wherein a given heading difference cluster comprises one or more identical heading differences;
identifying an outlier cluster within the generated two or more heading difference clusters; and
determining that the respective heading difference computed for the particular linear feature detection is associated with the identified outlier cluster.

18. The computer program product of claim 15, wherein for filtering based on the heading difference set, the operations further comprise:
determining that a respective heading difference computed for a particular one of the plurality of linear feature detections is greater than a heading difference threshold value; and
based on the respective heading difference computed for the particular linear feature detection being greater than the heading difference threshold value, discarding or disregarding the particular linear feature detection.

19. The computer program product of claim 15, wherein for filtering based on the generated one or more distance clusters, the operations further comprise:
identifying at least one pair of adjacent linear feature detections from the plurality of linear feature detections, based on the generated one or more distance clusters, wherein one linear feature detection of the identified at least one pair of adjacent linear feature detections is associated with a first distance cluster and another linear feature detection of the identified at least one pair of adjacent linear feature detections is associated with a second distance cluster; and
discarding or disregarding the identified at least one pair of adjacent linear feature detections from the plurality of linear feature detections.

20. The computer program product of claim 15, wherein for filtering based on the distance set, the operation further comprise filtering at least one linear feature detection from the plurality of linear feature detections, when at least one distance corresponding to the at least one linear feature detection is greater than a distance threshold value.
